(19) United States
(12) Patent Application Publication
(10) Pub. No.: US 2013/0181487 A1
(43) Pub. Date: Jul. 18, 2013

(54) Roof Bow

(71) Applicants: David Krueger, Grosse Ile, MI (US); Fadi A. El-Khatib, Abu Dhabi (AE); Marco Zhang, Canton, MI (US)

(72) Inventors: David Krueger, Grosse Ile, MI (US); Fadi A. El-Khatib, Abu Dhabi (AE); Marco Zhang, Canton, MI (US)

(73) Assignee: BASF SE, Ludwigshafen (DE)

(21) Appl. No.: 13/825,510

(22) PCT Filed: Sep. 22, 2011
(86) PCT No.: PCT/US2011/052781

§ 371 Date: Mar. 21, 2013

Related U.S. Application Data
(60) Provisional application No. 61/385,361, filed on Sep. 22, 2010.

(51) Int. Cl. B62D 25/06

(52) U.S. Cl. CPC B62D 25/06
USPC 296/210

(57) ABSTRACT

A roof bow (22) reduces noise and vibration of a motorized vehicle and includes a body having a length and two ends spaced apart from each other. The body also includes a metal and has thickness from about 0.25 mm to about 2 mm substantially along the length. Moreover, the body defines a base and first and second edges extending from the base. Each of the base and the first (34) and second (36) edges extend substantially along the length between the ends of the body. The first and second edges are each disposed transverse to the base and laterally spaced apart from each other substantially along the length. The roof bow also includes a plurality of ribs. The plurality of ribs (44) have a thickness from about 0.5 mm to about 5 mm and include a polymer. The plurality of ribs is disposed between the first and second edges and coupled to the body.

### FIELD OF THE INVENTION

The subject invention generally relates to a roof bow for reducing noise and vibration of a motorized vehicle. More specifically, the roof bow includes a body and a plurality of ribs, each having a particular thickness.

### DESCRIPTION OF THE RELATED ART

Articles that are used in industrial, commercial, and residential applications have tendencies to vibrate and produce unwanted noise. Appliances such as dishwashers, washing machines, and clothes dryers are typically fabricated from stainless steel in combination with other metals and plastics. When used, these appliances tend to produce high levels of noise and vibration which reverberate in the metals and are commercially undesirable.

Motorized vehicles, like appliances, are also typically fabricated from metals and plastics. Accordingly, motorized vehicles also tend to produce high levels of noise and vibration which reverberate in the metals and plastics. For this reason, it is well known in the art to study noise, vibration, and harshness (“NVH”), also known as noise and vibration (“N&V”), both in the interior and on the exterior of motorized vehicles. Interior NVH is measured relative to noise and vibration experienced by occupants of the motorized vehicles, while exterior NVH is measured relative to noise and vibration radiated by the motorized vehicles and typically includes drive-by noise testing. Although noise and vibration can be readily measured, harshness is a subjective quality that is typically measured either via “jury” evaluations or with analytical psychoacoustic tools that provide results reflecting human subjective impressions.

Sources of NVH in motorized vehicles are many including engines, drivelines, tire contacts, frame and structural elements, brakes, road surfaces, and wind. Many noises and vibrations are transmitted to the frame and structural elements of the motorized vehicles and then radiated acoustically into the cabins thereof. These types of noises and vibrations are typically classified as “structure-borne.” Other noises and vibrations are generated acoustically and are propagated by airborne paths and are typically classified as “airborne.” Structure-borne noises and vibrations are usually attenuated by isolation, while airborne noises and vibrations are typically reduced by absorption or through the use of barrier materials.

Traditionally, there have been three principal methods of improving NVH in both motorized vehicles and other articles. The first method includes reducing a strength of the source of the noise and vibration, such as through use of a muffler or by improving the balance of a rotating mechanism. The second method includes interrupting a path of the noise and vibration path through use of bathers and/or isolators. The third method includes absorbing the noise and vibration through use of foam noise absorbers. Other traditional means of improving NVH include use of tuned mass dampers, use of subframes, balancing of moving parts, modifying stiffness and mass of structures, retuning exhausts and intakes, modifying characteristics of isolators, adding sound deadening or absorbing materials, and using active noise controls.

Although each of these methods can be effective, many are expensive and are do not reduce weight and improve energy efficiency. In fact, many of these methods do just the opposite and add weight and reduce energy efficiency. This is counterproductive relative to current federal standards, along with proposed 2012 Federal Energy Star requirements and proposed Corporate Average Fuel Economy (CAFE) standards which greatly limit amount of energy that typical motorized vehicles, appliances, and the like, can consume. Many of the aforementioned mechanisms of reducing NVH are not compatible with such standards and requirements. Accordingly, there remains an opportunity to develop a support member that reduces noise and vibration in many different articles while reducing weight and improving energy efficiency.

### SUMMARY OF THE INVENTION AND ADVANTAGES

The instant invention provides a roof bow. The roof bow includes a body having a length and two ends spaced apart from each other. The body includes a metal, has thickness from about 0.25 mm to about 2 mm substantially along the length, and defines a base and first and second edges extending from the base. Each of the base and the first and second edges extend substantially along the length between the ends. The first and second edges are each disposed transverse to the base and laterally spaced apart from each other substantially along the length. The roof bow also includes a plurality of ribs having a thickness from about 0.5 mm to about 5 mm and includes a polymer. The plurality of ribs is disposed between the first and second edges and coupled to the body.

The metal and the polymer in the roof bow have unexpected synergies and produce unexpected reductions in noise, vibration, and harshness in motorized vehicles. The minimal thickness of both the metal and the polymer reduces total mass of the roof bow while maintaining structural strength and integrity and simultaneously improving the fuel economy and energy efficiency of the motorized vehicle. The reduction in total mass surprisingly leads to decreases in noise, vibration, and harshness in motorized vehicles.

### BRIEF DESCRIPTION OF THE DRAWINGS

Other advantages of the present invention will be readily appreciated, as the present invention becomes better understood by reference to the following detailed description when considered in connection with the accompanying drawings wherein:

FIG. 1A is a perspective view of a prior art roof bow that is formed from steel and that does not include any polymer;

FIG. 1B is a perspective view of a second prior art roof bow that is the same as the prior art roof bow of FIG. 1A but further includes a nylon 6 or metal cap attached thereto;

FIG. 2A is a perspective view of a frame of a motorized vehicle including one embodiment of the roof bow of the instant invention;

FIG. 2B is a top view of the frame of the motorized vehicle of FIG. 2A illustrating a roof assembly, side rail members, and other embodiments of the roof bow of the instant invention;

FIG. 3A is a perspective view of a motorized vehicle including A, B, and C pillars replaced and/or supplemented with various embodiments of the roof bow and including one embodiment of the roof bow disposed between B pillars;

FIG. 3B is a perspective view of a motorized vehicle including A and C pillars replaced and/or supplemented with various embodiments of the roof bow and including another embodiment of the roof bow disposed between A pillars;

FIG. 3C is a perspective view of a motorized vehicle including A, B, C, and D pillars replaced and/or supplemented with various embodiments of the roof bow and including still another embodiment of the roof bow disposed between D pillars;

FIG. 4A is a perspective view of one embodiment of the roof bow of the instant invention including first and second troughs and a plurality of ribs disposed in the first and second troughs in a modified (loose) cross pattern;

FIG. 4B is a perspective view of another embodiment of the roof bow of the instant invention including first and second troughs and a plurality of ribs disposed in the first and second troughs in a modified (loose) cross pattern;

FIG. 4C is a magnified view of the plurality of ribs of FIG. 4A in the modified (loose) cross pattern having an angle (θ) of about 45°;

FIG. 4D is a side cross-sectional view of the roof bow of FIG. 4a illustrating the thickness (T1) of the body of the roof bow;

FIG. 5A is a perspective view of an additional embodiment of the roof bow of the instant invention including first and second troughs and a plurality of ribs disposed in the first and second troughs in both a modified (loose) cross pattern and in a dense cross pattern;

FIG. 5B is a magnified view of the plurality of ribs of FIG. 5A in the dense cross pattern having an angle (α) of about 22.5°;

FIG. 6A is a perspective view of still another embodiment of the roof bow of the instant invention including a ridge, first and second troughs, and a plurality of ribs disposed in the first and second troughs approximately perpendicularly to the ridge;

FIG. 6B is a perspective view of a variation of the roof bow of FIG. 6A;

FIG. 6C is a perspective view of still another variation of the roof bow of FIG. 6A;

FIG. 6D is a magnified view of the plurality of ribs of FIG. 6A disposed approximately perpendicularly to the ridge at an angle (β) of about 90°;

FIG. 7A is a side cross-sectional view of an additional embodiment of the roof bow of the instant invention illustrating a width (W2) and length (L2) of the plurality of ribs;

FIG. 7B is a top view of the roof bow of FIG. 7A illustrating a thickness (T2) of the plurality of ribs;

FIG. 8A is a perspective view of yet another embodiment of the roof bow of the instant invention including first and second troughs and a plurality of ribs disposed in the first and second troughs in a modified (loose) cross pattern;

FIG. 8B is a perspective view of a variation of the roof bow of FIG. 8A;

FIG. 9 is a perspective view of still another embodiment of the roof bow of the instant invention illustrating the measurement positions Fore, Middle, and Aft, as represented in the Examples;

FIG. 10 is a line graph illustrating a sum of absolute value of Z-displacement of Bows 1-7 of the Examples as a function of the length of the plurality of ribs;

FIG. 11 is a line graph illustrating a sum of absolute value of Z-displacement of Bows 8-12 of the Examples as a function of the thickness (mm) of the plurality of ribs;

FIG. 12 is a line graph illustrating a sum of absolute value of Z-displacement of Bows 13-25 of the Examples as a function of the thickness (mm) of the body;

FIG. 13 is a line graph illustrating a sum of absolute value of Z-displacement of Bows 26-37 of the Examples as a function of the thickness (mm) of the plurality of ribs;

FIG. 14 is a line graph illustrating a weight of Bows 26-37 of the Examples as a function of the thickness (mm) of the plurality of ribs;

FIG. 15 is a table summarizing data of the Examples; and

FIG. 16 is an additional table that supplements FIG. 15 and sets forth the data of FIG. 15 wherein total Z-displacement of the Bows of the Examples is sorted in ascending order.

### DETAILED DESCRIPTION OF THE INVENTION

A support member is provided for reducing noise and vibration of an article. The article may be any known in the art and may be further defined as an appliance, a commercial, residential, or industrial structure, a mechanical assembly and/or sub-assembly, a tool, or a motorized vehicle (24) including, but not limited to, automobiles such as trucks, vans, and cars, boats, busses, etc. In various embodiments, the article is further defined as a dishwashing machine, a clothes washing machine, and/or a clothes drying machine.

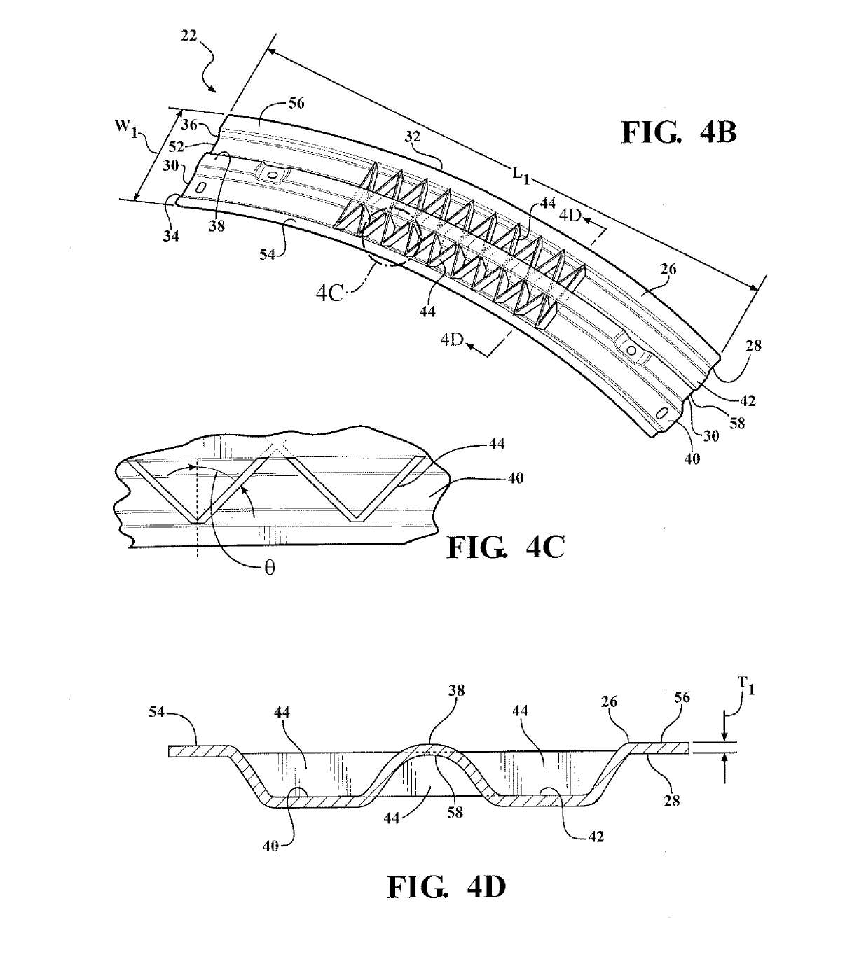

The support member itself may be of any type known in the art and may be further defined as a roof bow (22), roof header, support beam or segment, A/B/C and or D pillar of an automobile, girder, plank, bar, rafter, wall, exterior or interior member, stud, column, beam, plate, arch, shell, catenary, slab, plate, pier, lamina, dome, strut, header, footer, floor, sub-floor, truss, base, top, bottom, or side of the article. The support member may have any cross-section known in the art including, but not limited to, a rectangular cross-section, a square cross-section, a triangular cross-section, a circular or oval cross-section, an “I”-shaped cross-section, a “C”-shaped cross-section, an “L”-shaped cross-section, a “T”-shaped cross-section, a “U”-shaped cross-section, or a “W” shaped cross-section, as shown in FIG. 4D. The support member may be solid, hollow, or have solid sections and hollow sections. Most typically, the support member is further defined as the roof bow (22) and the article is further defined as the motorized vehicle (24).

### Body of the Support Member:

The support member has a body (32) that has a top side (26) and a bottom side (28). The body (32) may be curvilinear or linear or may include curvilinear segments and linear segments. The body (32) may be monolithic, e.g. formed from a single material, or may be formed from two or more materials. In various embodiments, the terminology “formed from a single material” refers to the body (32) including greater than about 50, 55, 60, 65, 70, 75, 80, 85, 90, or 95 weight percent of the single material. Alternatively, the body (32) may include from about 95 to about 100, from about 97 to about 100, from about 99 to about 100, or about 100, weight percent of the single material.

The body (32) typically includes a metal. The metal may include, but is not limited to, steel, aluminum, stainless steel, iron, ferrous metals, base metals, noble metals, transition metals, alloys thereof, and combinations thereof. The body (32) may consist essentially of the metal or consist of the metal. In various embodiments, if the body (32) consists essentially of the metal, the body (32) typically does not include polymers, metals other than steel, aluminum, stainless steel, iron, etc. In other embodiments, the body (32) consists essentially of steel, aluminum, iron, and/or stainless steel and typically does not include other types of metals or polymers. In another embodiment, the body (32) consists essentially of steel and iron. In still other embodiments, the body (32) consists essentially of steel, stainless steel, iron, and aluminum. The body (32) may be protected from corrosion by galvanization, painting or other corrosion protection methods.

The body (32) has a length (L₁), width (W₁), and thickness (T₁) and has two ends (30) spaced apart from each other, typically along the length (L₁) or substantially along the length (L₁) as shown in the Figures. The body (32) may have any length (L₁) and width (W₁). In various embodiments, the body (32) has a length (L₁) from about 1 inch to about 1 foot, from about 1 to about 10 feet, from about 2 to about 7 feet, from about 3 to about 5 feet, from about 3 to about 6 feet, or from about 4 to about 5 feet. In other embodiments, the body (32) has a width (W₁) from about 0.1 to about 12 inches, from about 2 to about 6 inches, from about 3 to about 4 inches, from about ½ to about 1 foot, from about 1 to about 5 feet, from about 2 to about 4 feet, or from about 2 to about 3, feet. Alternatively, if the support member is used in a structure or large article, the body (32) may have a length (L₁) and/or width (W₁) that is greater than about 5, 10, 20, 30, 40, or 50 feet or even larger.

The thickness (T₁) of the body (32) may be constant or can vary and typically is from about 0.25 mm to about 2 mm along the length (L₁) or substantially along the length (L₁). In various embodiments, the body (32) has a thickness (T₁) that is constant or can vary and is from about 0.25 mm to about 0.55 mm, from about 0.50 mm to about 0.75 mm, from about 0.75 mm to about 1 mm, from about 1 mm to about 1.25 mm, from about 1.25 mm to about 1.50 mm, from about 1.50 mm to about 1.75 mm, from about 1.75 mm to about 2 mm, from about 1 mm to about 2 mm, from about 1.5 mm to about 2 mm, or from about 0.5 mm to about 1 mm, substantially along the length (L₁). Of course, it is to be understood that the body (32) may have any length (L₁), thickness (T₁), or width (W₁) or any range(s) of length/thicknesses/width within the aforementioned ranges in both whole and fractional values. Any one or more of the length/thickness/width may vary by ±1, 2, 43, 4, 5, 10, 15, 20+%, etc.

### Segments of the Support Member:

In addition to the body (32), the support member also includes one or more segments (e.g. ribs (44)) disposed on or in the body (32) to assist in reduction of noise and vibration of the article. Each of the segments may independently be curvilinear or linear or include curvilinear portions and linear portions. Each of the segments may independently be monolithic, e.g. formed from a single material, or may be formed from two or more materials. Each of the segments may also independently include a metal that may be the same or different from those described above and/or may include a polymer. One or more of the segments may be monolithic while other segments may be formed from two or more materials.

In various embodiments, the terminology “formed from a single material” refers to one or more of the segments independently including greater than about 50, 55, 60, 65, 70, 75, 80, 85, 90, or 95 weight percent of the single material. Alternatively, each of the segments may independently include from about 95 to about 100, from about 97 to about 100, from about 99 to about 100, or about 100, weight percent of the single material.

The polymer first introduced above may be any known in the art and may include one or more thermoplastic polymers, thermoset polymers, nylons, polystyrenes, polyvinylchlorides, rubbers, and/or one or more of polyethylene terephthalate, high-density polyethylene, low-density polyethylene, polypropylene, polyethylene, and the like. In various embodiments, the polymer is further defined as one or more of nylon 6, nylon 6/6, and/or nylon 6/66. In other embodiments, the polymer is further defined as polybutylene terephthalate (PBT) and/or polypropylene (PP). In one embodiment, the polymer is selected from the group of nylon 6, PBT, PP, and combinations thereof. In even other embodiments, the polymer includes, consists essentially of, or consists of a polymer selected from the group of polyolefins, polyesters, polyamides, macromolecules, engineering polymers, plastics, and combinations thereof. In other embodiments, the polymer includes, consists essentially of, or consists of a polymer selected from the group of polyolefins, polyesters, polyamides, engineering polymers, plastics, and combinations thereof. In still further embodiments, the polymer includes, consists essentially of, or consists of a polymer selected from the group of polyolefins, polyesters, polyamides, and combinations thereof.

Each of the segments may independently consist essentially of the polymer or consist of the polymer. In various embodiments, if one or more of the segments consists essentially of the polymer, then each segment typically does not include metals. In one embodiment, one or more of the segments consists essentially of nylon 6. In another embodiment, one or more of the segments consists essentially of nylon 6 and another polymer, such as nylon 6/6, nylon 6/66, or a thermoplastic polymer. In additional embodiments, one or more of the segments consists essentially of, or consists of, PBT, PP, and/or combinations thereof. The segments may be protected from corrosion by galvanization, painting or other corrosion protection methods.

Each of the segments also has a length (L₂), width (W₂), and thickness (T₂). The thickness (T₂) typically ranges from about 0.5 mm to about 5 mm. In various embodiments, this thickness (T₂) ranges from about 1 mm to about 5 mm, from about 2 mm to about 4 mm, from about 0.5 mm to about 3 mm, from about 0.5 mm to about 0.75 mm, from about 0.75 mm to about 1 mm, from about 1.75 to about 4 mm, from about 1 mm to about 1.25 mm, from about 1.25 mm to about 1.5 mm, from about 1.5 mm to about 1.75 mm, from about 1.75 mm to about 2 mm, from about 2 mm to about 2.25 mm, from about 2.25 mm to about 2.5 mm, from about 2.5 mm to about 2.75 mm, from about 2.75 mm to about 3 mm, from about 1 mm to about 2 mm, from about 1 to about 3 mm, from about 1.5 mm to about 2 mm, from about 0.5 mm to about 1 mm, from about 2 mm to about 3 mm, or from about 1.5 mm to about 3 mm.

The segments may have any length (L₂) and width (W₂). In various embodiments, one or more of the segments has a length (L₂) from about 1 to about 100 mm, from about 1 to about 50 mm, from about 1 to about 25 mm, from about 20 to about 40 mm, from about 20 to about 30 mm, from about 10 to about 40 mm, from about 50 to about 100 mm, from about 1 inch to about 1 foot, from about 1 to about 10 feet, from about 2 to about 7 feet, from about 3 to about 6 feet, or from about 4 to about 5 feet. In other embodiments, one or more of the segments has a width (W₂) from about 1 to about 100 mm, from about 1 to about 50 mm, from about 1 to about 25 mm, from about 20 to about 40 mm, from about 20 to about 30 mm, from about 10 to about 40 mm, from about 50 to about 100 mm, from about 0.1 to about 12 inches, from about ½ to about 1 foot, from about 1 to about 5 feet, from about 2 to about 4 feet, or from about 2 to about 3, feet. Alternatively, if the support member is used in a structure or large article, one or more of the segments may have a length (L₂) and/or width (W₂) that is greater than about 5, 10, 20, 30, 40, or 50 feet or even larger. Of course, it is to be understood that one or more of the segments may have any length (L₂), thickness (T₂), or width (W₂) or any range(s) of length/thicknesses/width within the aforementioned ranges in both whole and fractional values. Any one or more of the length/thickness/width may vary by ±1, 2, 43, 4, 5, 10, 15, 20+%, etc.

The segments are typically disposed on or in the body (32). Most typically, the body (32) and the segments are disposed in direct contact with each other at one or more contact points on the body (32) and/or one or more of the segments (e.g., at a top, bottom, and/or one or more sides of one of more of the segments). However, the instant invention is not limited to such an embodiment. The body (32) and one or more of the segments may be coupled-connected- or attached- to each other or may be “disposed on” one another even without a direct connection or attachment. For example, there may be a material disposed between the body (32) and one or more segments and the segments may still be coupled, connected, or attached, to the body (32). Said differently, the body (32) and one or more of the segments may be disposed on one another even if separated by space or by another section or portion of the support member. In one embodiment, the body (32) and one or more of the segments are bonded to each other with an adhesive. Alternatively, the segments may be overmolded on or around the body (32).

### Support Member for Reducing Noise and Vibration of the Motorized Vehicle:

In various embodiments, the support member is further defined as a support member for reducing noise and vibration (and typically harshness) of the motorized vehicle (24), as shown in the various Figures and as described above. The support member may be further defined as a roof bow (22) for reducing noise and vibration of the motorized vehicle (24), as also described above. In one embodiment, the body (32) is curvilinear, has the length and two ends (30) described above, and includes the metal. In this embodiment, the body (32) also has a thickness from about 0.25 mm to about 2 mm substantially along the length.

In another embodiment, the body (32) defines a base (52) and first and second edges (34, 36) extending from the base (52). Each of the base (52) and the first and second edges (34, 36) typically extend substantially along the length between the ends (30). The first and second edges (34, 36) are typically each disposed transverse to the base (52) and laterally spaced apart from each other substantially along the length. In one embodiment, the base (52) and the first and second edges (34, 36) form a “U” shaped channel. It is contemplated that a portion of the body (32) may include one or both of the first and second edges (34, 36) while one or more other portions of the body may be free of one or both of the first and second edges (34, 36).

In various embodiments, first and second flanges (54, 56) are disposed approximately perpendicularly to the first and second edges (34, 36), respectively. It is contemplated that a portion of the body (32) may include one or both of the first and second flanges (54, 56) while one or more other portions of the body may be free of one or both of the first and second flanges (54, 56). The first and second flanges (54, 56) are not particularly limited in length, width, or thickness, and typically extend the length of the body and have a width from about 1 to about 10 mm, from about 2 to about 8 mm, from about 3 to about 7 mm, from about 4 to about 6 mm, from about 6 to about 8 mm, from about 0.1 to about 12 inches, from about ½ to about 1 foot, from about 1 to about 5 feet, from about 2 to about 4 feet, or from about 2 to about 3, feet. The first and second flanges (54, 56) also typically have the same thickness as the body (32). Each of the first and second flanges (54, 56) may have the same size and shape as each other or may have different sizes and/or shapes. Of course, it is to be understood that each of the first and second flanges (54, 56) may have may have any thickness/width or range of thicknesses/width within the aforementioned ranges in both whole and fractional values.

In another embodiment, the support member includes a ridge (38) extending from the base (52) substantially along the length of the body (32) between the ends (30) thereby defining a first trough (40) between the ridge (38) and the first edge (34) and a second trough between the ridge (38) and the second edge. The first and second troughs (40, 42) are typically on the top side (26) of the body (32). The ridge (38) also typically defines a third trough (58) on the bottom side (28) of the body (32). The first, second, and third troughs (40, 42, 58) typically extend substantially along the length of the body (32).

It is contemplated that a portion of the body (32) may include one or both of the first and second troughs (40, 42) while one or more other portions of the body may be free of one or both of the first and second troughs (40, 42). Similarly, it is contemplated that a portion of the body (32) may include the third trough (58) while one or more other portions of the body may be free of the third trough (58).

The first, second, and/or third troughs (40, 42, 58) typically each have a width from about 1 to about 100 mm, from about 1 to about 50 mm, from about 1 to about 25 mm, from about 20 to about 40 mm, from about 20 to about 30 mm, from about 10 to about 40 mm, from about 50 to about 100 mm, from about 1 inch to about 1 foot, from about 1 to about 10 feet, from about 2 to about 7 feet, from about 3 to about 6 feet, or from about 4 to about 5 feet. The first, second, and third troughs (40, 42, 58) also each typically have a depth from about 1 to about 100 mm, from about 1 to about 50 mm, from about 1 to about 25 mm, from about 20 to about 40 mm, from about 20 to about 30 mm, from about 10 to about 40 mm, from about 50 to about 100 mm, from about 0.1 to about 1 inch, from about 0.2 to about 0.8 inches, from about 0.3 to about 0.7 inches, from about 0.4 to about 0.6 inches, from about 1 to about 12 inches, from about ½ to about 1 foot, from about 1 to about 5 feet, from about 2 to about 4 feet, or from about 2 to about 3, feet.

The body (32), e.g. the ridge (38), also typically has an axis extending therefrom. In one embodiment, the axis extends horizontally, or approximately horizontally, therefrom. In another embodiment, the axis is disposed approximately perpendicularly to the body (32) and/or the ridge (38). If the body is curvilinear, the axis may be alternatively described as disposed approximately perpendicular to a line tangent to the curvilinear body (32) or to the body (32) itself. The terminology “approximately perpendicularly” describes that the axis is disposed perpendicularly from the body within about 0.1 to about 1, 2, 3, 4, 5, 6, 7, 8, 9, or 10, degrees. The terminology “approximately horizontally” may also be further described as horizontally within about 0.1 to about 1, 2, 3, 4, 5, 6, 7, 8, 9, or 10, degrees.

The body (32), e.g. the ridge (38), also typically has an axis extending therefrom. In one embodiment, the axis extends horizontally, or approximately horizontally, therefrom. In another embodiment, the axis is disposed approximately perpendicularly to the body (32) and/or the ridge (38). If the body is curvilinear, the axis may be alternatively described as disposed approximately perpendicular to a line tangent to the curvilinear body (32) or to the body (32) itself. The terminology “approximately perpendicularly” describes that the axis is disposed perpendicularly from the body within about 0.1 to about 1, 2, 3, 4, 5, 6, 7, 8, 9, or 10, degrees. The terminology “approximately horizontally” may also be further described as horizontally within about 0.1 to about 1, 2, 3, 4, 5, 6, 7, 8, 9, or 10, degrees.

### Plurality of Ribs

The support member for reducing the noise and vibration of the motorized vehicle (24) may also include one or more of the segments described above. Most typically, the segments are further defined as a plurality of ribs (44). The plurality of ribs may include at least two or at least three individual ribs (44). The plurality of ribs (44) may be disposed in at least one of the first and second troughs (40, 42) and may be disposed in both. Alternatively, the plurality of ribs (44) may be described as disposed between the first and second edges (34, 36). The plurality of ribs (44) may also be disposed in the third trough (58) either exclusively or in combination with ribs disposed in the first and/or second troughs (40, 42). In various embodiments, the plurality of ribs (44) is disposed in one or both of the first and second troughs (40, 42) and a second plurality of ribs is disposed in the third trough (58). The plurality of ribs (44) may be further defined in any way as the segments are described above or they may be different.

One or more of the plurality of ribs (44) may be different from one or more other individual ribs (44) that make up the plurality of ribs (44). For example, certain numbers of individual ribs (44) that make up the plurality of ribs (44) may have certain sizes, dimensions, orientations, compositions, etc. that fall within the scope of the invention and others individual ribs (44) of the plurality of ribs (44) may be different in one or more of the aforementioned characteristics. Said differently, it is contemplated that not all of the ribs (44) in the plurality of ribs (44) needs to be the same or even similar to one another.

The plurality of ribs (44) (and/or the second plurality of ribs) may be disposed in any pattern relative to the body (32), the ridge (38), and/or the axis including, but not limited to, a square pattern, a dense cross pattern, and a modified (i.e., “loose) cross pattern. The plurality of ribs (44) (and/or the second plurality of ribs) may also be disposed approximately perpendicularly or transverse to the body (32), the ridge (38) or axis whether on the top side (26) or bottom side (28) of the body (32). It is also contemplated that the plurality of ribs (44) (and/or the second plurality of ribs) can be disposed in one of the first, second, and/or third trough (40, 42, 58) in any of the aforementioned patterns and disposed in the one or both of the other troughs in the same or a different pattern.

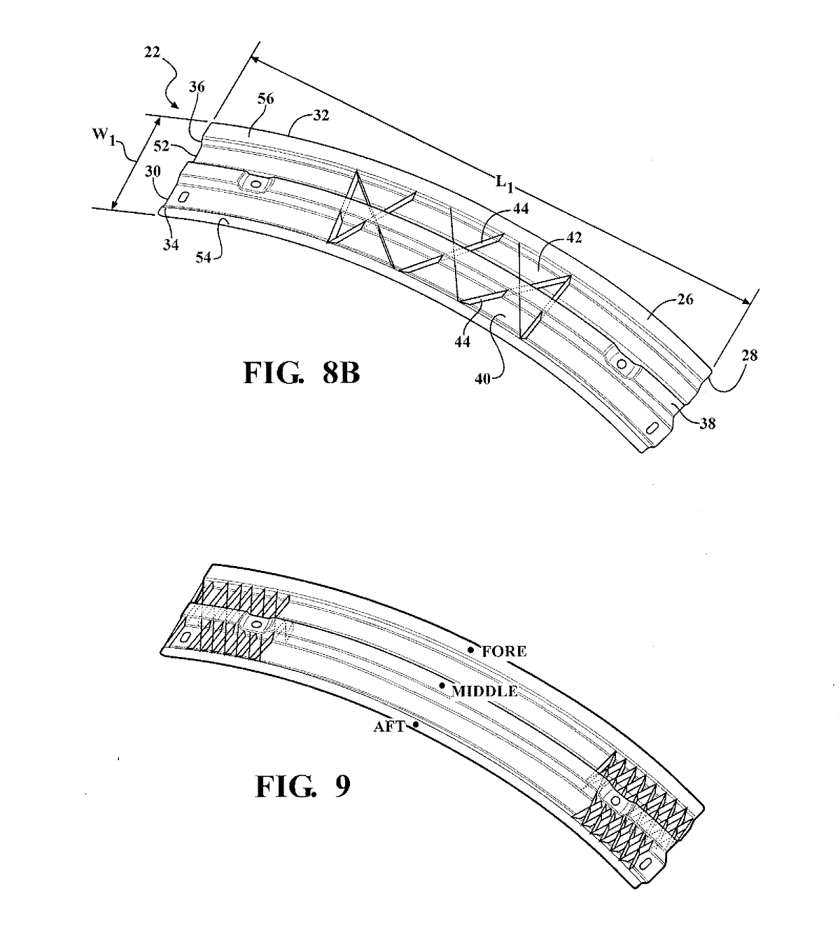

The plurality of ribs (44) (and/or the second plurality of ribs) in the loose cross pattern is typically disposed transverse (i.e., at an angle) to the axis but may also or alternatively be disposed transverse to the body (32) and/or the ridge (38). However, this angle is usually larger than the angle associated with the dense cross pattern. Non-limiting examples of a loose cross pattern of the plurality of ribs (44) are illustrated in FIGS. 4A, 4B, 4C, 8A, and 8B. As shown in these Figures, the plurality of ribs (44) in this pattern is disposed at an angle (θ) of approximately 45, 40 to 50, 35 to 50, 45 to 85, 55 to 75, or 65 to 75, degrees (±1, 2, 3, 4, 5, 6, 7, 8, 9, or 10 degrees) to the axis. It is also contemplated that the plurality of ribs (44) (and/or the second plurality of ribs) in this pattern may be described as being disposed at an angle that is complementary to the angles described above and/or shown in the Figures, e.g. disposed transverse to the ridge (38) at a complementary angle.

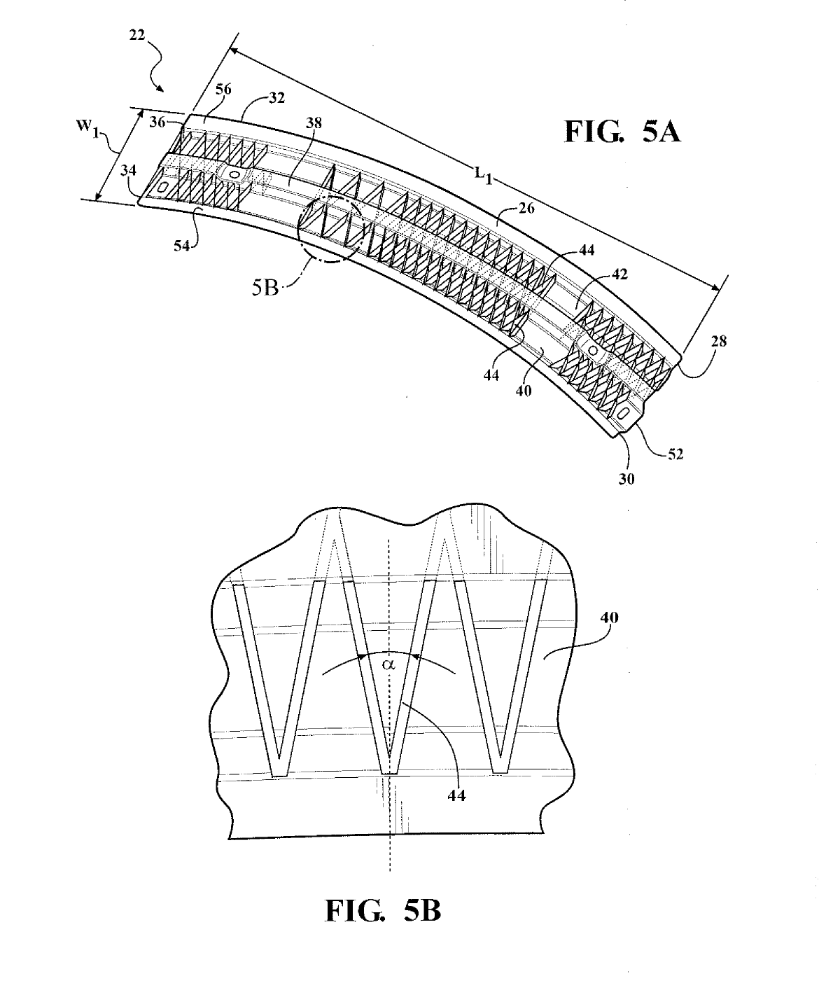

The plurality of ribs (44) (and/or the second plurality of ribs) in the dense cross pattern is also typically disposed transverse (i.e., at an angle) to the axis but may also or alternatively be disposed transverse to the body (32) and/or the ridge (38). Non-limiting examples of a dense cross pattern of the plurality of ribs (44) are illustrated in FIGS. 5A and 5B. As shown in these Figures, the plurality of ribs (44) in this pattern is disposed at an angle (α) approximately 5 to 35, 10 to 25, 15 to 20, 20 to 25, or at about 22 to 23, degrees (±1, 2, 3, 4, 5, 6, 7, 8, 9, or 10 degrees) to an axis extending perpendicularly from the ridge (38). It is also contemplated that the plurality of ribs (44) (and/or the second plurality of ribs) in this pattern may be described as being disposed at an angle that is complementary to the angles described above and/or shown in the Figures, e.g. disposed transverse to the ridge (38) at a complementary angle.

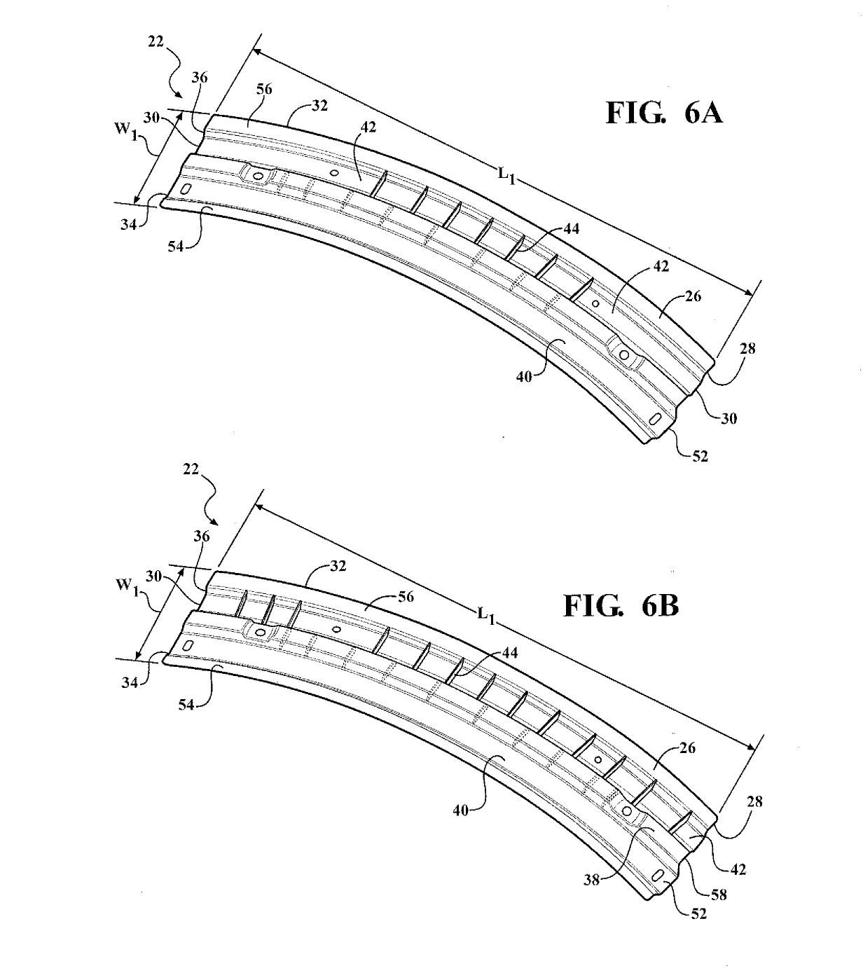

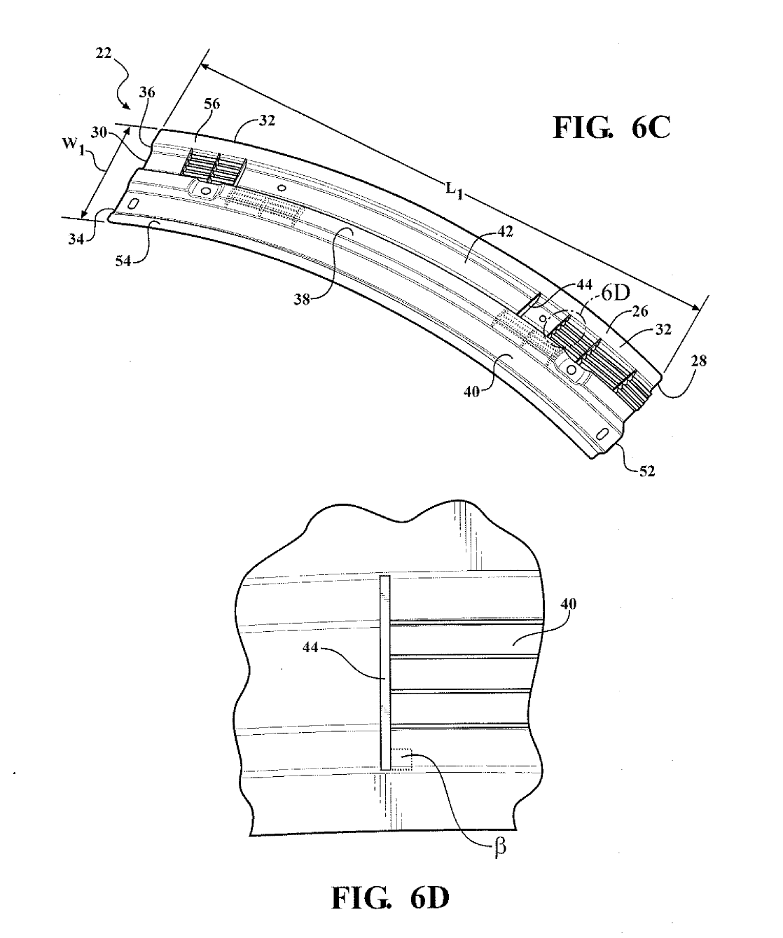

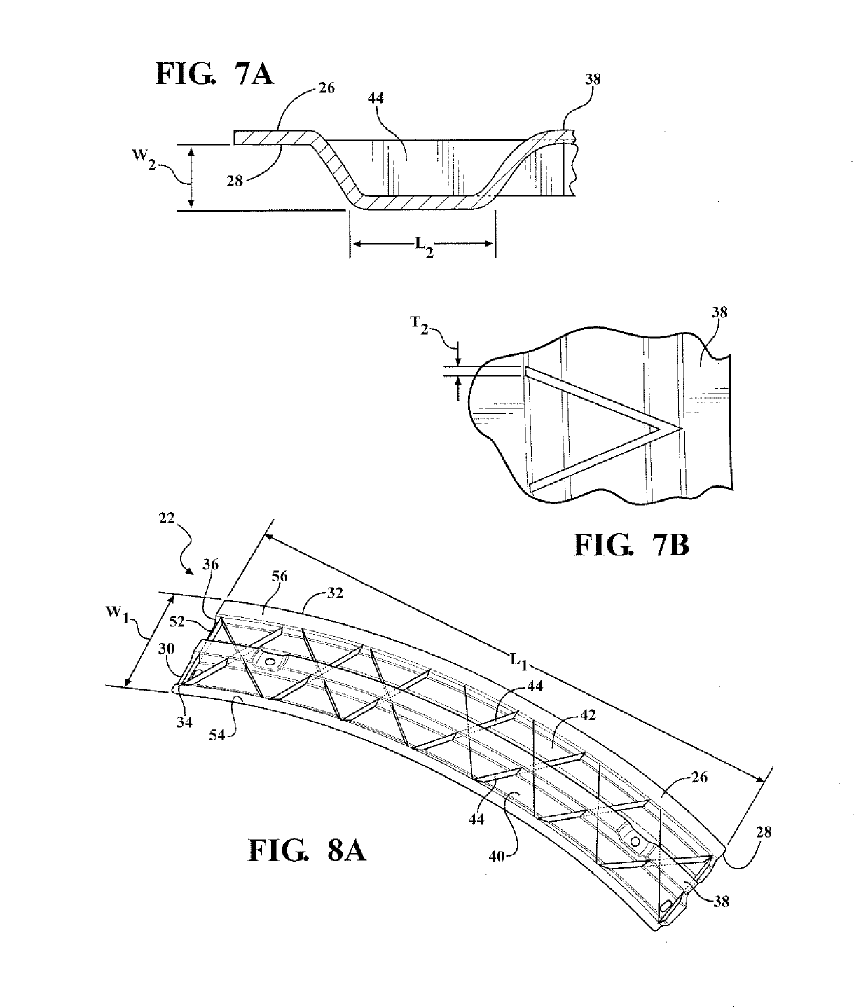

Non-limiting examples of a square pattern of the plurality of ribs (44) (e.g. those disposed in the second and third troughs (42, 58)) are illustrated in FIGS. 6A, 6B, and 6C. Typically, the plurality of ribs (44) (and/or the second plurality of ribs) in the square pattern is disposed in at least one of the first and second troughs (40, 42) approximately parallel to each other. In addition, the plurality of ribs (44) in this pattern is typically disposed along the axis perpendicular to the body (32) and/or the ridge (38), as shown in FIGS. 6A, 6B, and 6C. Alternatively, the plurality of ribs (44) (and/or the second plurality of ribs) may be disposed at an approximately perpendicular angle (β) (±1, 2, 3, 4, 5, 6, 7, 8, 9, or 10 degrees) relative to the axis and or the ridge (38).

### Additional Non-Limiting Embodiments of the Roof Bow:

In one embodiment, the support member is further defined as a roof bow (22) that includes the body (32) having the length and two ends (30) spaced apart from each other substantially along the length. The body (32) also includes the metal and has a thickness from 0.25 mm to 2 mm substantially along the length. In addition, the body (32) defines the base (52) and the first and second edges (34, 36) extending from the base (52). Each of the base (52) and the first and second edges (34, 36) extend substantially along the length between the ends (30). Moreover, the first and second edges (34, 36) are each disposed transverse to the base (52) and laterally spaced apart from each other substantially along the length. In this embodiment, the roof bow (22) also includes the ridge (38) extending from the base (52) substantially along the length of the body (32) between the ends. The ridge (38) defines the first trough (40) between the ridge (38) and the first edge (34) and the second trough (42) between the ridge (38) and the second edge (36). In this embodiment, the roof bow (22) also includes the plurality of ribs (44) disposed in at least one of the first and second troughs (40, 42). The plurality of ribs (44) includes the polymer and may have a thickness from 0.5 mm to 5 mm.

### Roof Assembly:

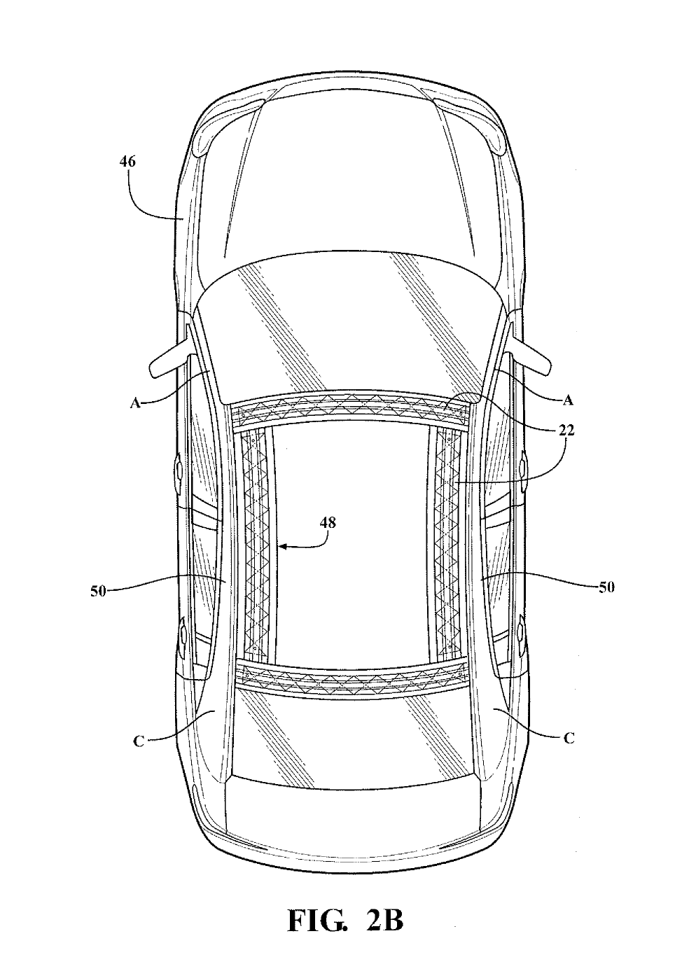

Referring now to one particular embodiment, the article is further defined as a motorized vehicle (24), such as an automobile, having a frame (46) and a roof assembly (48), as shown in FIG. 2B. The roof assembly (48) may be removable or permanent, and may include hard and/or soft segments, and may be retractable either manually or electrically.

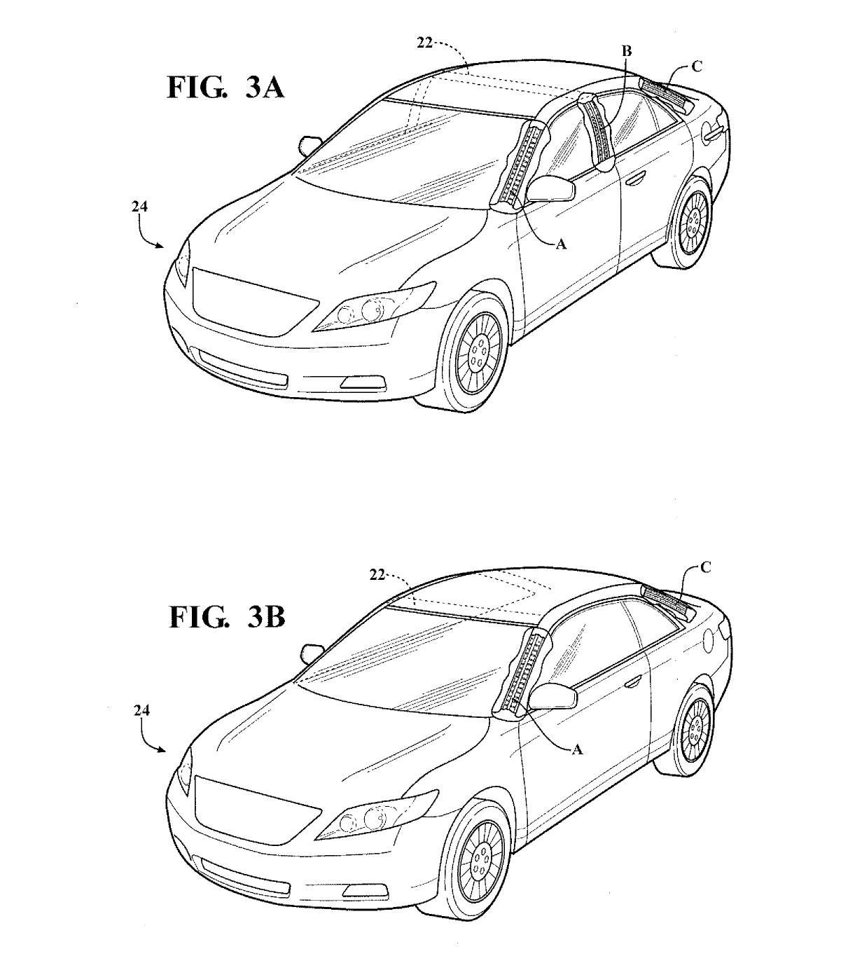

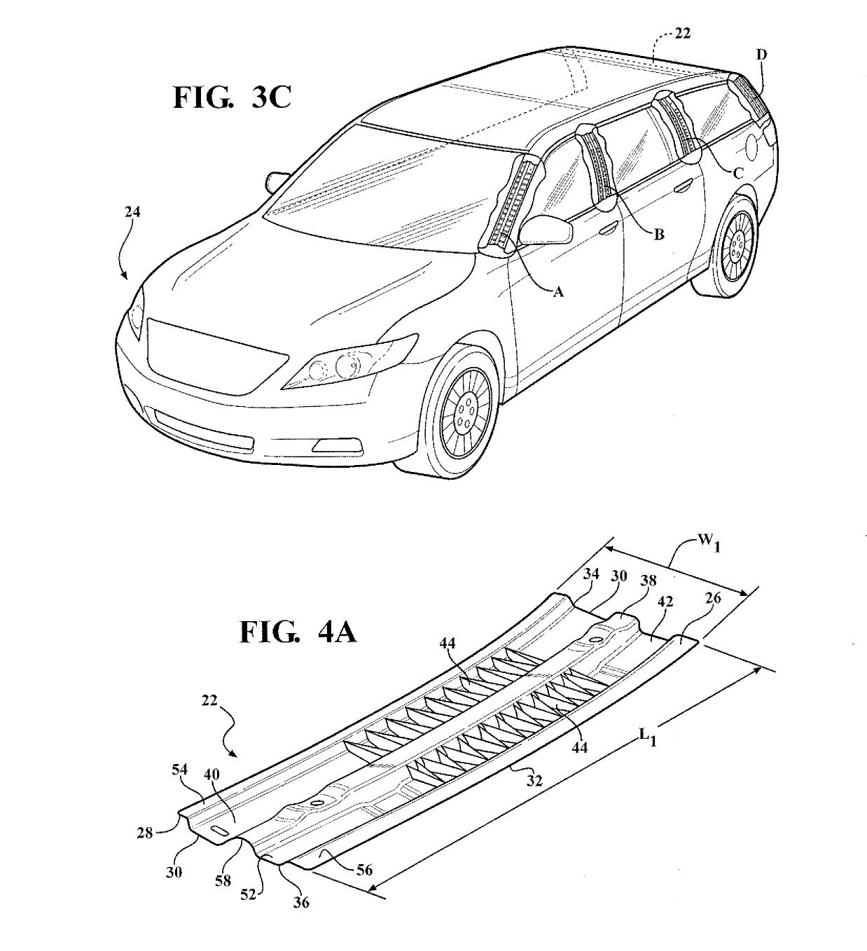

The roof assembly (48) typically includes a pair of side rail members (50) laterally spaced from each other and disposed approximately parallel to the frame (46) of the motorized vehicle (24), as shown in FIG. 2B. The roof assembly (48) also typically includes a pair of pillars connected to the frame (46) of the motorized vehicle (24) that are laterally spaced from each other and that are connected to the pair of side rail members (50). Each of the pair of pillars are typically further defined as “A” pillars, “B” pillars, “C” pillars, and/or “D” pillars extending therefrom, as shown in FIGS. 2B and 3A, 3B, and 3C. Most typically, the frame (46) includes at least two “A” pillars and at least two “C” pillars extending therefrom. Typically, the one or more pillars extend vertically (or at an angle) from the frame (46) and are connected to the side rail members (50). Of course, it is to be understood that the roof assembly (48) may include two or more than two of any of the A, B, C, and/or D pillars.

Typically, the support member extends between the pair of side rail members (50) and the pair of pillars, e.g. between the “A” pillars, “B” pillars, “C” pillars, and/or “D” pillars. Said differently, the support member typically extends between the one or more pillars approximately perpendicularly to the side rail members (50) of the roof. In these embodiments, the support member is typically further defined as the roof bow (22), but is not limited in this way. In one embodiment, the support member extends between the “C” pillars. In another embodiment, the support member extends between the “A” pillars. It is also contemplated that one or more of the pair of side rail members (50) and/or pillars may be replaced and/or supplemented with various embodiments of the roof bow. The instant invention also provides a motorized vehicle itself that includes the roof bow and/or roof assembly described above.

The support member, roof bow, and/or roof assembly may each be formed by any method known in the art. In one embodiment, the roof bow is formed using a method that includes the steps of providing the body (32), providing the plurality of ribs (44), and disposing the plurality of ribs (44) in or on the body (32). In another embodiment, the roof assembly is formed using a method that includes the steps of providing the pair of side rail members, providing the pair of pillars, providing the roof bow, and disposing the roof bow between the pair of side rail member and the pair of pillars. The aforementioned steps of providing are not particularly limited. Typically, the step of disposing is further defined as attaching or locating via adhesion, welding, or the like.

### Examples

### Evaluation of Sum of Displacement as a Function of Length of Plurality of Ribs

A first series of roof bows (Bows 1-7) are formed according to the instant invention. The Bows 1-7 generally include the body, ridge, and first, second, and third troughs, as described above. The body has a thickness of about 0.75 (mm) and a length of about 1047 mm. The ridge has a height (and the first, second, and third troughs have a depth) of about 18 mm. The Bows 1-7 also include the plurality of ribs disposed in the first and second troughs. The body includes steel as the metal while the plurality of ribs include nylon 6 as the polymer.

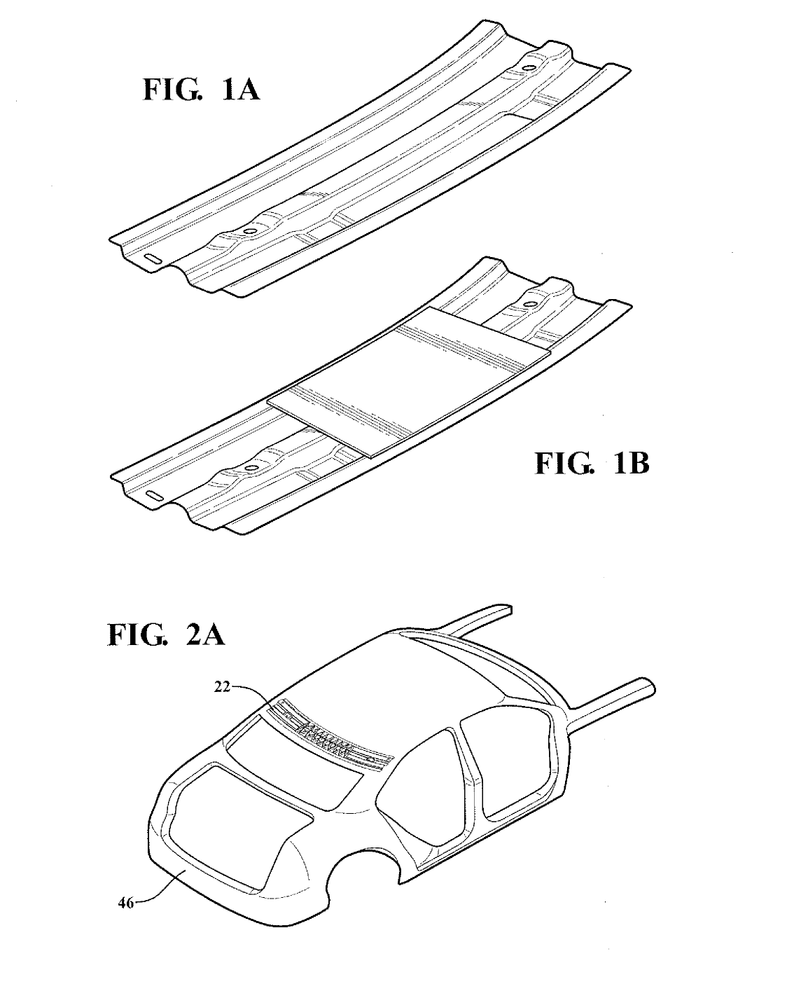

Two control bows (Control Bows 1 and 2) are also formed but not according to this invention. Control Bows 1 and 2 have the same shape, length, thickness, and height as the Bows 1-7 and are formed from the same steel. However, Control Bow 1 does not include any plurality of ribs or any nylon 6 and is generally shown in FIG. 1A. Control Bow 2 does not include any ribs but includes a nylon 6 cap of 450 mm dimensions disposed on the top of the Bow, as generally shown in FIG. 1B.

Relative to Bows 1-3, the plurality of ribs are disposed in a “square” pattern as generally shown in FIGS. 6A, 6B, and 6C. Each of plurality of ribs in the Bows 1-3 has a thickness of about 3.5 mm, and a length of approximately 0.18, 0.38, and 0.58 inches, respectively.

Relative to Bows 4 and 5, the plurality of ribs are disposed in a “dense cross” pattern as generally shown in FIGS. 5A and 5B. Each of plurality of ribs in the Bows 4 and 5 has a thickness of about 3.5 mm, and a length of approximately 0.2 and 0.6 inches, respectively.

Relative to Bows 6 and 7, the plurality of ribs are disposed in a “loose cross” pattern as generally shown in FIGS. 4A, 4B, and 4C. Each of plurality of ribs in the Bows 6 and 7 has a thickness of about 3.5 mm, and a length of approximately 0.19 and 0.58 inches, respectively.

Each of the Bows 1-7 is evaluated using modeling software (commercially available from Altair company under the trade name of HyperWorks) to determine maximum Z-displacement at three points on each Bow: Fore, Middle, and Aft. Each of the Fore, Middle, and Aft points are located in approximately the middle of each Bow, relative to its length, as shown in FIG. 9. The “Fore” point is located in approximately a front edge location. The “Middle” point is located in approximately a middle location. The “Aft” point is located in approximately a rear edge location.

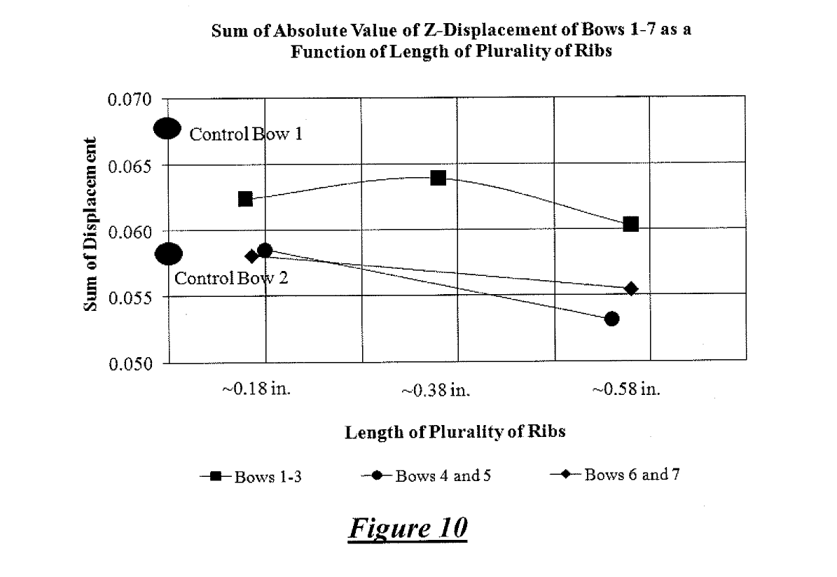

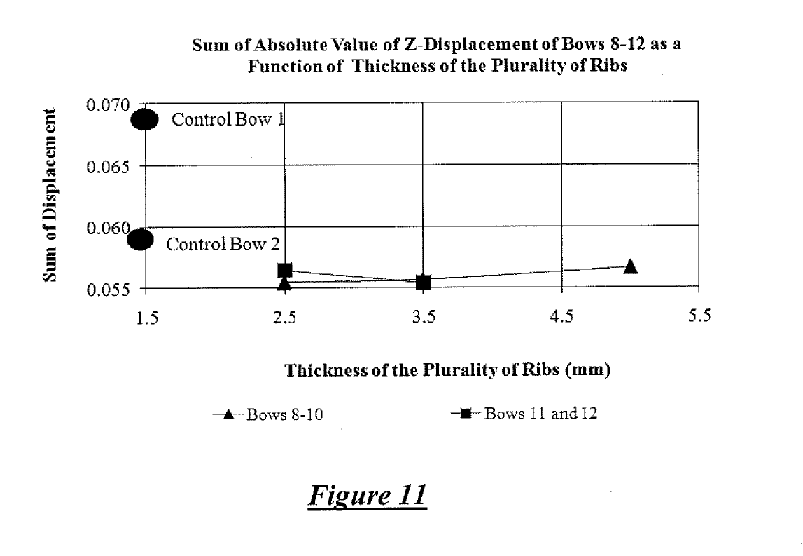

The Z-displacement calculations are set forth in Table 1 below wherein all data is in mm. The sum of the absolute values of each maximum Z-displacement at each of the Fore, Middle, and Aft points for each of the Bows 1-7 and the Control Bows 1 and 2 is then calculated. The data relative to Bows 1-7 is set forth in FIG. 10 as a function of length of the plurality of ribs.

TABLE 1

| | Fore | Middle | Aft | Sum |
|---|---|---|---|---|
| Control Bow 1 | 0.0148 | 0.0235 | 0.0296 | 0.0679 |
| Control Bow 2 | 0.0130 | 0.0223 | 0.0226 | 0.0579 |
| Bow 1 | 0.0124 | 0.0221 | 0.0258 | 0.0603 |
| Bow 2 | 0.0158 | 0.0222 | 0.0259 | 0.0639 |
| Bow 3 | 0.0153 | 0.0224 | 0.0247 | 0.0624 |
| Bow 4 | 0.0122 | 0.0214 | 0.0196 | 0.0531 |
| Bow 5 | 0.0132 | 0.0221 | 0.0232 | 0.0585 |
| Bow 6 | 0.0131 | 0.0227 | 0.0223 | 0.0581 |
| Bow 7 | 0.0126 | 0.0222 | 0.0207 | 0.0555 |

### Evaluation of Sum of Displacement as a Function of Thickness of the Plurality of Ribs:

A second series of roof bows (Bows 8-12) are also formed according to the instant invention. The Bows 8-12 also generally include the body, ridge, the first and second troughs, and the plurality of ribs, as described above. The Control Bows 1 and 2 are also used as comparative examples.

Relative to Bows 8-10, the plurality of ribs are disposed in the “dense cross” pattern described above and generally shown in FIGS. 5A and 5B. The plurality of ribs in each of Bows 8-10 has a length of about 450 mm and a thickness of 2.5, 3.5, and 5 mm, respectively.

Relative to Bows 11 and 12, the plurality of ribs are disposed in a “loose cross” pattern as generally shown in FIG. 4A-4C. The plurality of ribs in each of Bows 6 and 7 has a length of about 450 mm and a thickness of approximately 2.5 and 3.5 mm, respectively.

Each of the Bows 8-12 is evaluated using HyperWorks to determine Z-displacement at the three points: Fore, Middle, and Aft, described above. The Z-displacement calculations are set forth in Table 2 below wherein all data is in mm. The sum of the absolute values of each maximum Z-displacement at each of the Fore, Middle, and Aft points for each of the Bows 8-12 and the Control Bows 1 and 2 is then calculated. The data relative to Bows 8-12 is set forth in FIG. 11 as a function of thickness (mm) of the plurality of ribs.

TABLE 2

| | Fore | Middle | Aft | Sum |
|---|---|---|---|---|
| Control Bow 1 | 0.0148 | 0.0235 | 0.0296 | 0.0679 |
| Control Bow 2 | 0.0130 | 0.0223 | 0.0226 | 0.0579 |
| Bow 8 | 0.0122 | 0.0222 | 0.0211 | 0.0555 |
| Bow 9 | 0.0124 | 0.0222 | 0.0211 | 0.0557 |
| Bow 10 | 0.0128 | 0.0222 | 0.0217 | 0.0567 |
| Bow 11 | 0.0130 | 0.0224 | 0.0211 | 0.0565 |
| Bow 12 | 0.0126 | 0.0222 | 0.0207 | 0.0555 |

### Evaluation of Sum of Displacement as a Function of Thickness of the Body:

A third series of roof bows (Bows 13-25) are also formed according to the instant invention. The Bows 13-25 also generally include the body, ridge, the first and second troughs, and the plurality of ribs, as described above. The Control Bows 1 and 2 are also used as comparative examples.

However, additional control bows (Control Bows 3-12) are also formed. Control Bows 3-12 have the same shape, length, thickness, and height as the Control Bows 1 and 2 and are formed from the same steel. However, Control Bows 3-5 do not include any plurality of ribs or any nylon 6. Control Bows 6-8 do not include any ribs but each includes a nylon 6 cap disposed on the top of the Bow, as generally shown in FIG. 1B. Control Bows 1 and 2 each have a thickness of about 0.75 mm. Control Bows 3 and 6 each have a thickness of about 0.55 mm. Control Bows 4 and 7 each have a thickness of about 0.65 mm. Control Bows 5 and 8 each have a thickness of about 0.70 mm.

In addition, Control Bows 9-12 do not include any plurality of ribs or any nylon 6. Instead, each of these Control bows have a thickness of about 0.75 mm and include a steel cap disposed on the top of each Bow. The caps disposed on the top of Control Bows 9-12 have a thickness of about 0.75, 0.65, 0.55, and 0.70 mm each, respectively.

Relative to Bows 13-16, the plurality of ribs are disposed in the “dense cross” pattern described above and generally shown in FIGS. 5A and 5B. The plurality of ribs in each of Bows 13-16 has a length of about 450 mm and a thickness of 2.5 mm. The curvilinear bodies of the Bows 13-16 have a thickness of 0.55, 0.65, 0.65, and 0.75 mm, respectively.

Relative to Bows 17-19, the plurality of ribs are disposed in the same “dense cross” pattern as Bows 13-16. The plurality of ribs in each of Bows 17-19 has a length of about 450 mm and a thickness of 3.5 mm. The curvilinear bodies of the Bows 17-19 have a thickness of 0.65, 0.7, and 0.75 mm, respectively.

Relative to Bows 20-22, the plurality of ribs are disposed in the “loose cross” pattern described above and generally shown in FIGS. 4A-C. The plurality of ribs in each of Bows 20-22 has a length of about 1047 mm and a thickness of 2.5 mm. The curvilinear bodies of the Bows 20-22 have a thickness of 0.75, 0.65, and 0.55 mm, respectively.

Relative to Bows 23-25, the plurality of ribs are disposed in the same “loose cross’ pattern as Bows 20-22. The plurality of ribs in each of Bows 23-25 has a length of about 1047 mm and a thickness of 3.5 mm. The curvilinear bodies of the Bows 23-25 have a thickness of 0.75, 0.65, and 0.55 mm, respectively.

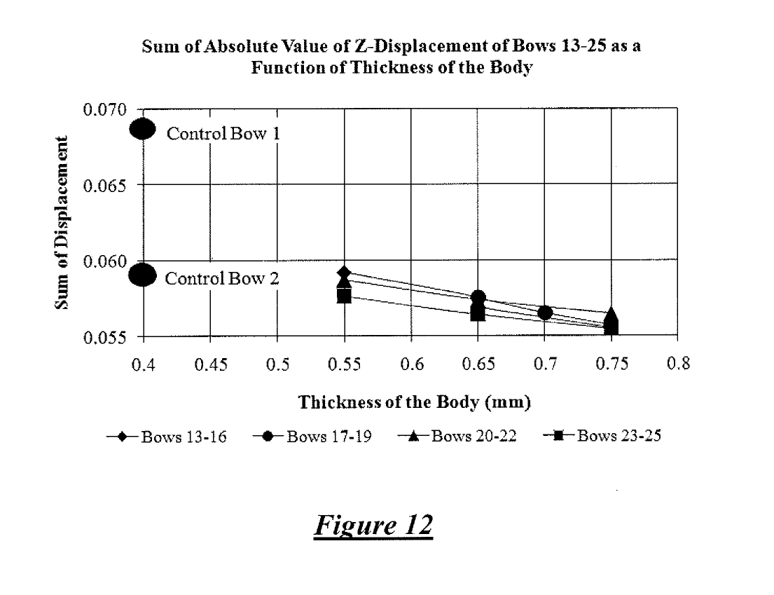

Each of the Bows 13-25 and Control Bows 1-12 is evaluated using HyperWorks to determine Z-displacement at the three points: Fore, Middle, and Aft, described above. The Z-displacement calculations are set forth in Table 3 below wherein all data is in mm. The sum of the absolute values of each maximum Z-displacement at each of the Fore, Middle, and Aft points for each of the Bows 13-25 and the Control Bows 1-12 is then calculated. The data relative to Bows 13-25 is set forth in FIG. 12 as a function of thickness of the body.

TABLE 3

| | Fore | Middle | Aft | Sum |
|---|---|---|---|---|
| Control Bow 1 | 0.0148 | 0.0235 | 0.0296 | 0.0679 |
| Control Bow 2 | 0.0130 | 0.0223 | 0.0226 | 0.0579 |
| Control Bow 3 | 0.0153 | 0.0245 | 0.0310 | 0.0708 |
| Control Bow 4 | 0.0146 | 0.0240 | 0.0303 | 0.0690 |
| Control Bow 5 | 0.0147 | 0.0237 | 0.0300 | 0.0684 |
| Control Bow 6 | 0.0136 | 0.0230 | 0.0246 | 0.0612 |
| Control Bow 7 | 0.0130 | 0.0227 | 0.0231 | 0.0588 |
| Control Bow 8 | 0.0128 | 0.0225 | 0.0225 | 0.0578 |
| Control Bow 9 | 0.0124 | 0.0222 | 0.0211 | 0.0557 |
| Control Bow 10 | 0.0122 | 0.0223 | 0.0208 | 0.0554 |
| Control Bow 11 | 0.0124 | 0.0224 | 0.0212 | 0.0559 |
| Control Bow 12 | 0.0125 | 0.0223 | 0.0214 | 0.0562 |
| Bow 13 | 0.0132 | 0.0230 | 0.0230 | 0.0592 |
| Bow 14 | 0.0128 | 0.0226 | 0.0221 | 0.0575 |
| Bow 15 | 0.0126 | 0.0226 | 0.0217 | 0.0569 |
| Bow 16 | 0.0122 | 0.0222 | 0.0211 | 0.0555 |
| Bow 17 | 0.0128 | 0.0226 | 0.0221 | 0.0575 |
| Bow 18 | 0.0126 | 0.0224 | 0.0215 | 0.0565 |
| Bow 19 | 0.0124 | 0.0222 | 0.0211 | 0.0557 |
| Bow 20 | 0.0130 | 0.0224 | 0.0211 | 0.0565 |
| Bow 21 | 0.0133 | 0.0227 | 0.0214 | 0.0574 |
| Bow 22 | 0.0137 | 0.0230 | 0.0220 | 0.0587 |
| Bow 23 | 0.0126 | 0.0222 | 0.0207 | 0.0555 |
| Bow 24 | 0.0129 | 0.0224 | 0.0210 | 0.0564 |
| Bow 25 | 0.0134 | 0.0228 | 0.0215 | 0.0577 |

### Additional Evaluation of Sum of Displacement—Function of Thickness of Plurality of Ribs:

A fourth series of roof bows (Bows 26-37) are also formed according to the instant invention. The Bows 26-37 are identical to the Bows 1-7 described above but include variations in placement and design of the plurality of ribs and in the thickness of the plurality of ribs. Bows 26-29 and 32 include the plurality of ribs in a configuration as set forth in FIG. 4A. Bows 30, 31, and 33 include the plurality of ribs in a configuration as set forth in FIG. 8A. Bows 34-37 include the plurality of ribs in a configuration as set forth in FIG. 8B. The Control Bows 1 and 2 are also used as comparative examples.

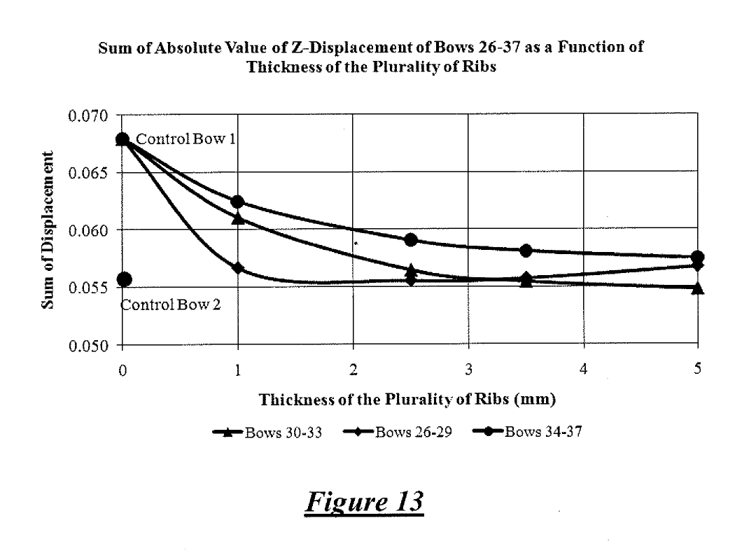

Each of the Bows 26-37 is evaluated using HyperWorks to determine Z-displacement at the three points: Fore, Middle, and Aft, described above. The Z-displacement calculations are set forth in Table 4 below wherein all data is in mm. The sum of the absolute values of each maximum Z-displacement at each of the Fore, Middle, and Aft points for each of the Bows 26-37 and the Control Bows 1 and 2 is then calculated. The data relative to Bows 26-37 is set forth in FIG. 13 as a function of thickness (mm) of the plurality of ribs and summarized below.

TABLE 4

| | Fore | Middle | Aft | Sum |
|---|---|---|---|---|
| Control Bow 1 | 0.0148 | 0.0235 | 0.0296 | 0.0679 |
| Control Bow 2 | 0.0130 | 0.0223 | 0.0226 | 0.0579 |
| Bow 26 | 0.0126 | 0.0225 | 0.0215 | 0.0566 |
| Bow 27 | 0.0122 | 0.0222 | 0.0211 | 0.0555 |
| Bow 28 | 0.0124 | 0.0222 | 0.0211 | 0.0557 |
| Bow 29 | 0.0128 | 0.0222 | 0.0217 | 0.0567 |
| Bow 30 | 0.0142 | 0.0229 | 0.0239 | 0.0610 |
| Bow 31 | 0.0130 | 0.0224 | 0.0211 | 0.0565 |
| Bow 32 | 0.0124 | 0.0222 | 0.0211 | 0.0557 |
| Bow 33 | 0.0125 | 0.0220 | 0.0203 | 0.0548 |
| Bow 34 | 0.0144 | 0.0230 | 0.0251 | 0.0625 |
| Bow 35 | 0.0134 | 0.0228 | 0.0229 | 0.0591 |
| Bow 36 | 0.0131 | 0.0227 | 0.0223 | 0.0581 |
| Bow 37 | 0.0129 | 0.0225 | 0.0219 | 0.0573 |

### Additional Evaluation of Sum of Displacement:

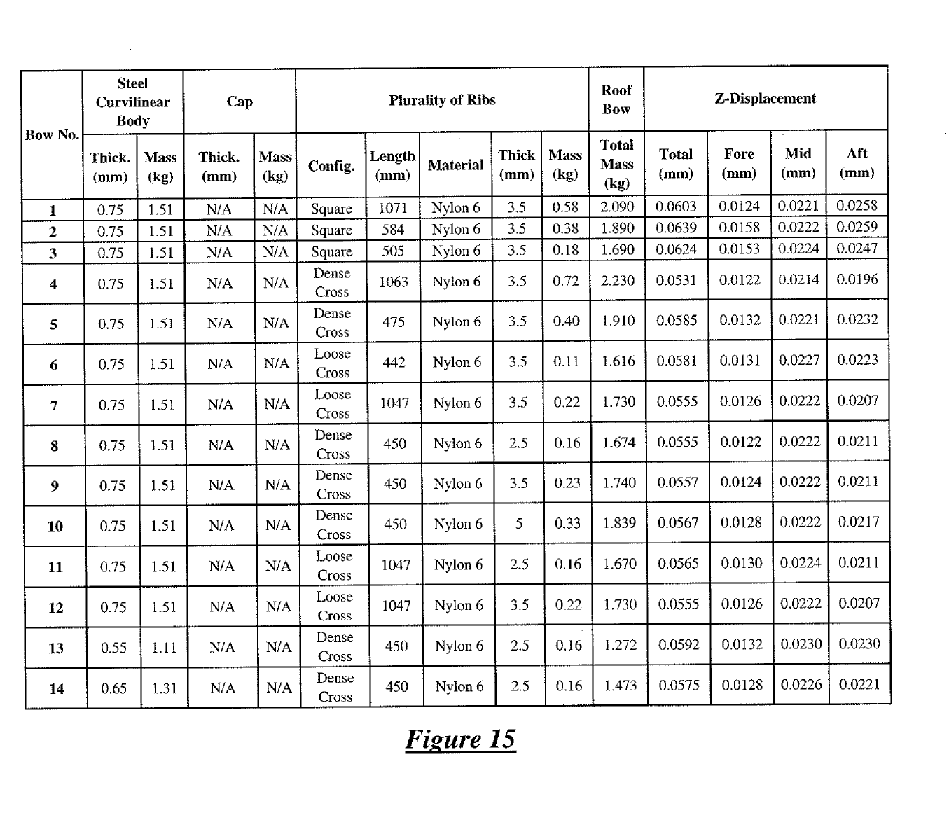

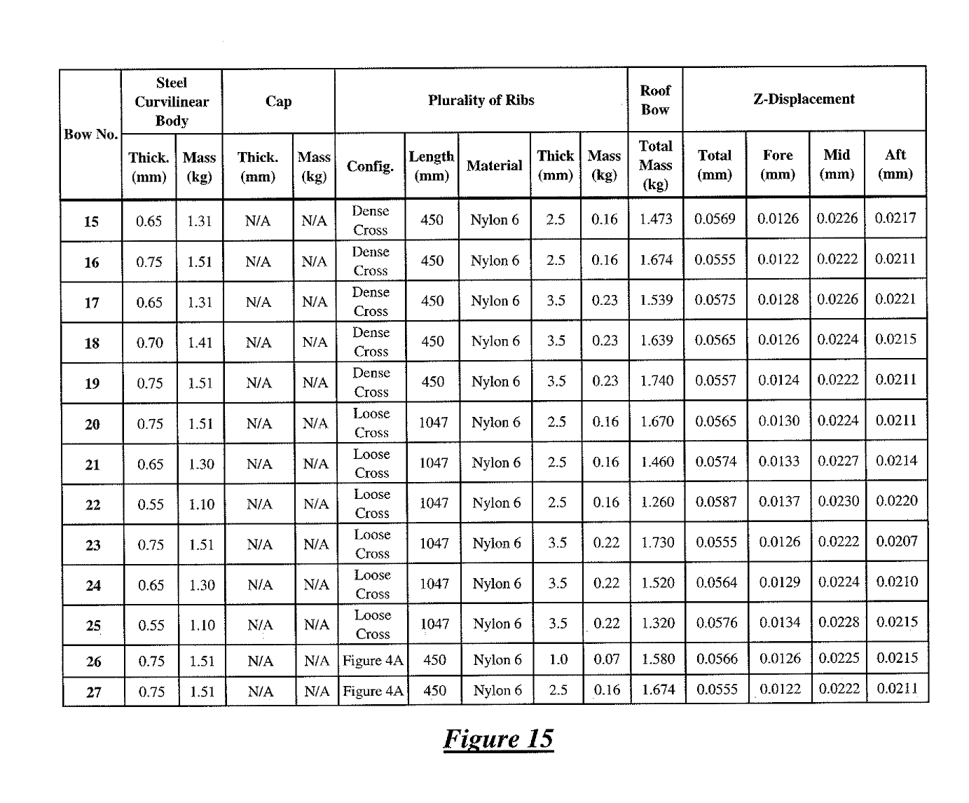

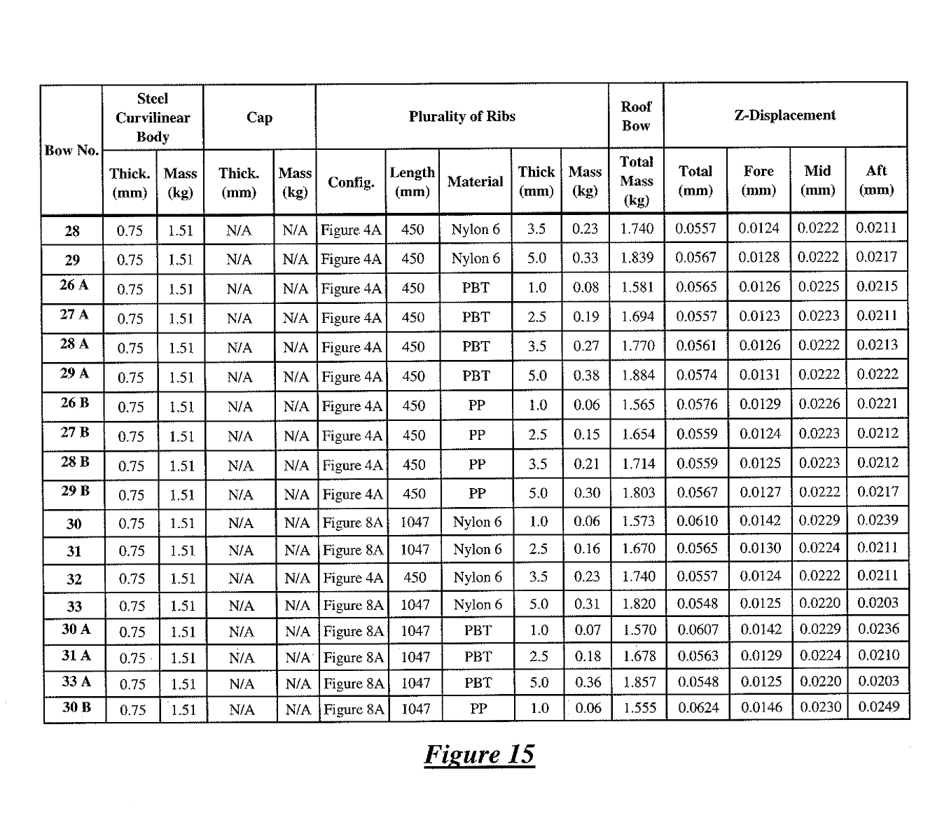

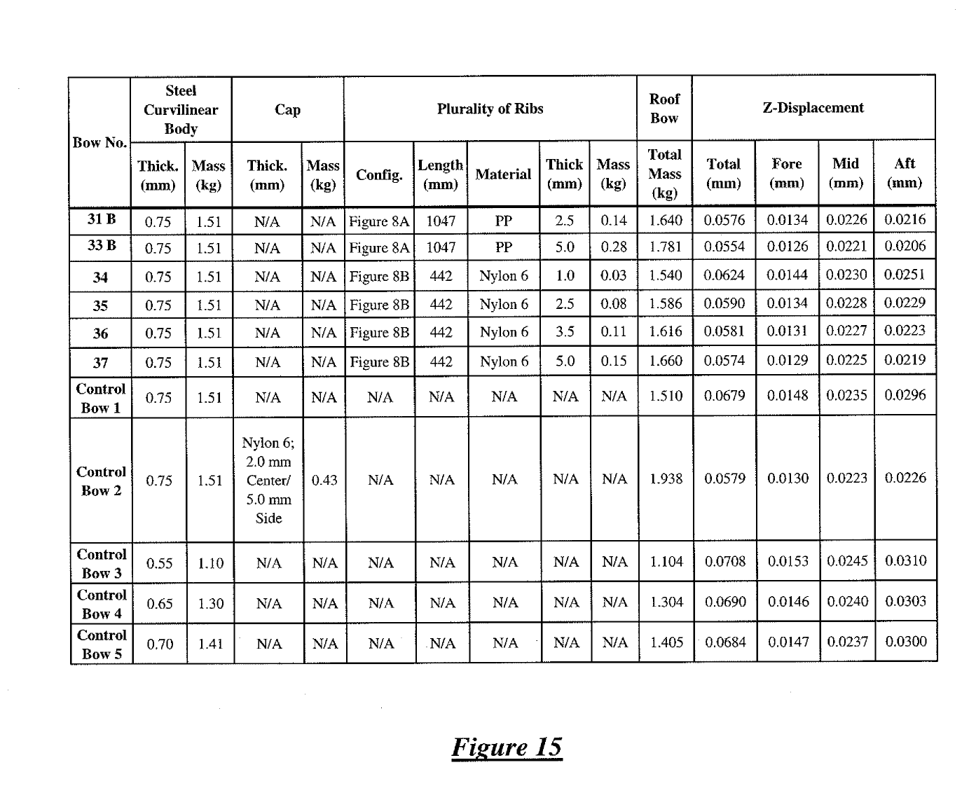

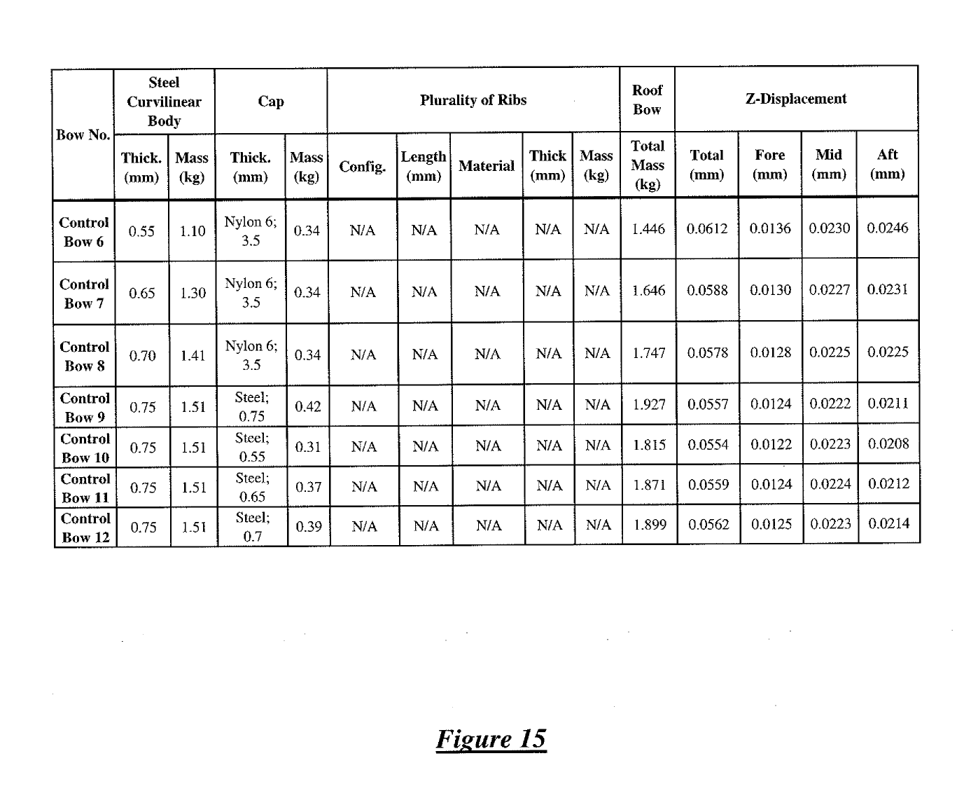

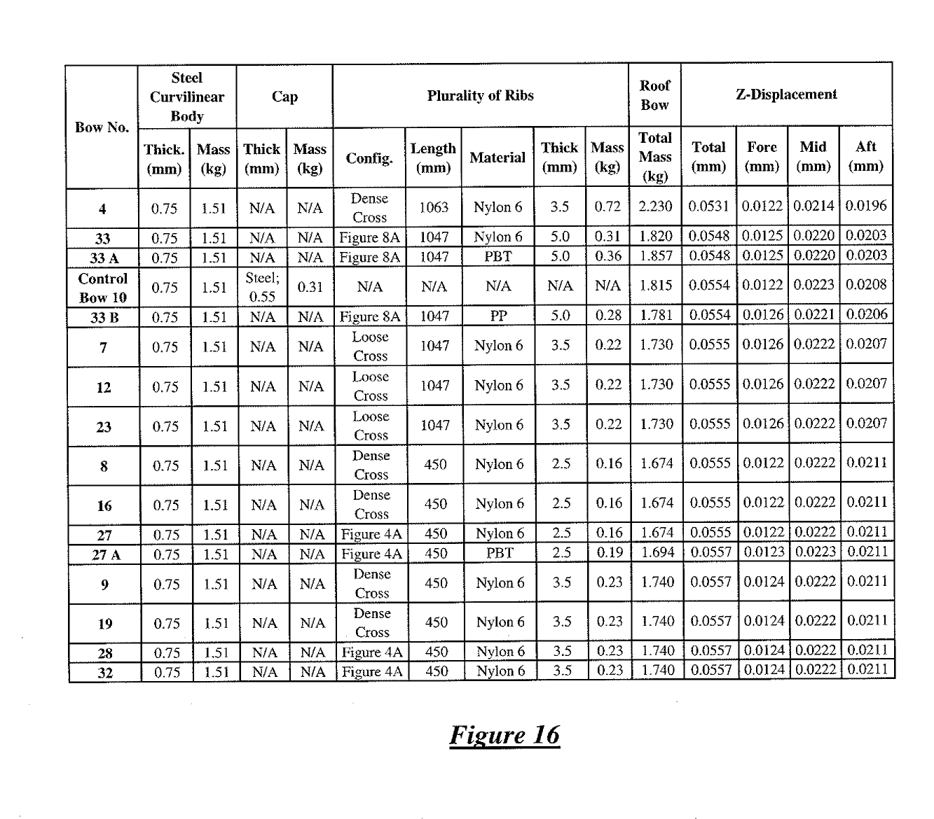

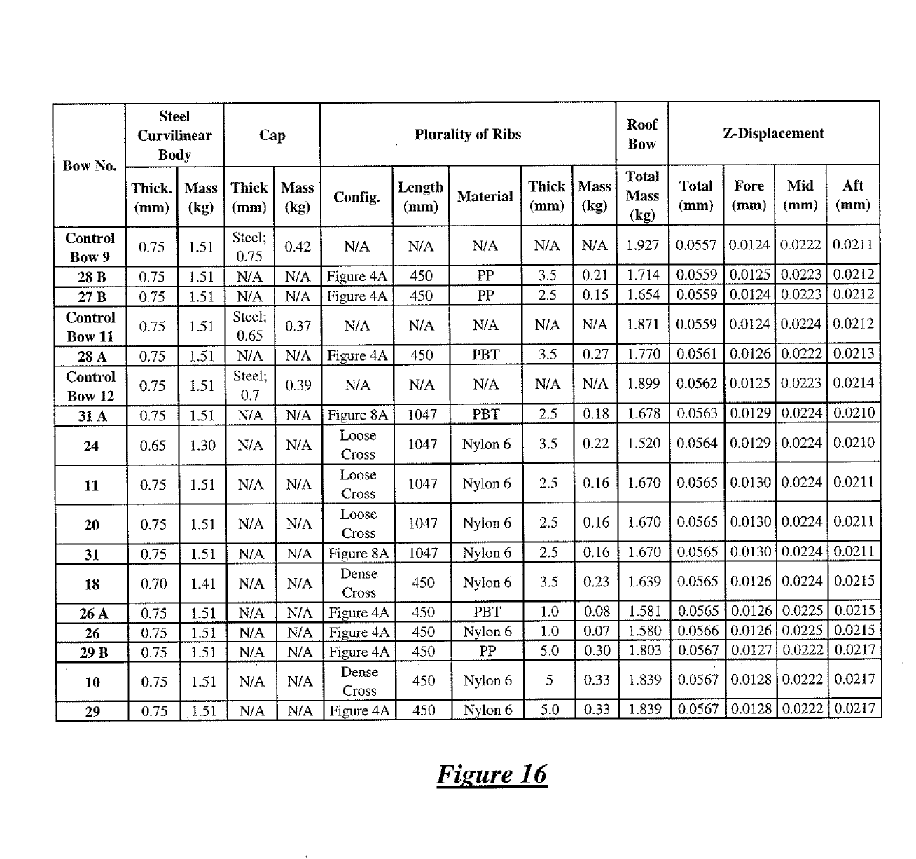

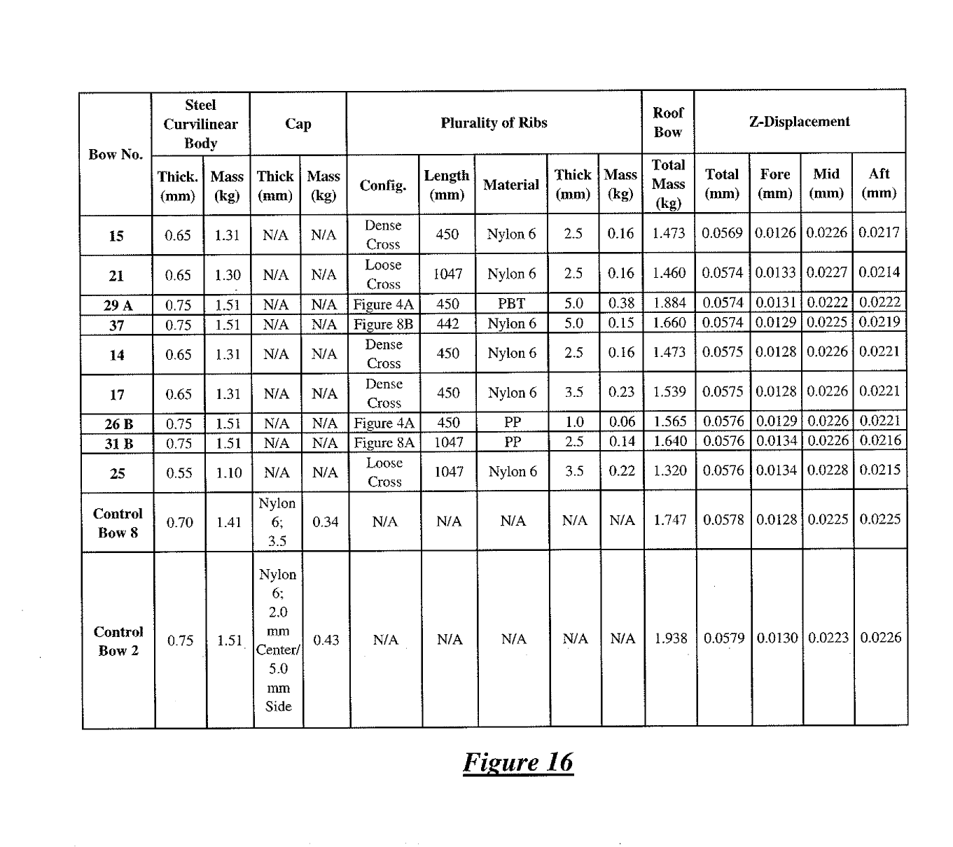

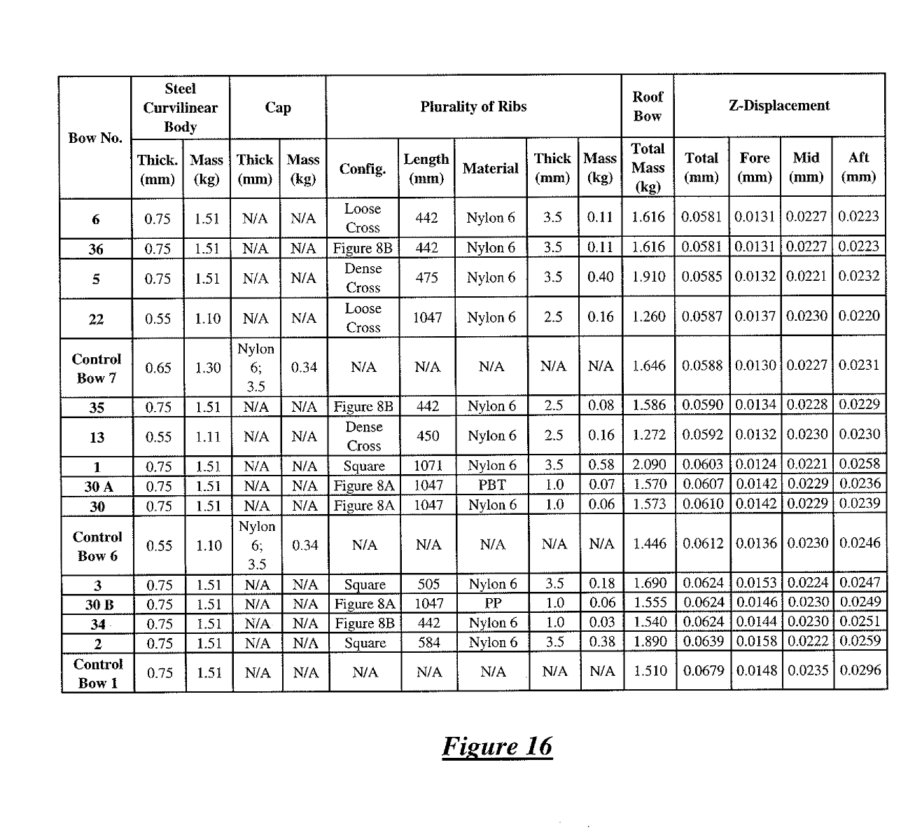

Fourteen additional roof bows (Bows 26A/B, 27A/B, 28A/B, 29A/B, 30A/B, 31A/B, and 33A/B) are also formed. These additional roof bows are identical to Bows 26-31 and 33 above, respectively, except that Bows 26A-31A and 33A are formed using PBT (polybutylene terephthalate) instead of nylon 6, as the polymer. Bows 26A-31A and 33A are representative of the bow configuration illustrated in FIG. 4A. Bows 26B-31B and 33B are formed using PP (polypropylene) instead of nylon 6, as the polymer. Bows 26B-31B and 33B are representative of the bow configuration illustrated in FIG. 8A. Each of the additional Bows is evaluated in the same ways as Bows 26-31 and 33 above. The data relative to these additional Bows is summarized below and set forth in FIG. 15. The data from Table 4 associated with Control Bows 1 and 2 is also reproduced below simply for convenience of comparison.

TABLE 4A

| | Fore | Middle | Aft | Sum |
|---|---|---|---|---|
| Bow 26 A | 0.0126 | 0.0225 | 0.0215 | 0.0565 |
| Bow 27 A | 0.0123 | 0.0223 | 0.0211 | 0.0557 |
| Bow 28 A | 0.0126 | 0.0222 | 0.0213 | 0.0561 |
| Bow 29 A | 0.0131 | 0.0222 | 0.0222 | 0.0574 |
| Bow 26 B | 0.0129 | 0.0226 | 0.0221 | 0.0576 |
| Bow 27 B | 0.0124 | 0.0223 | 0.0212 | 0.0559 |
| Bow 28 B | 0.0125 | 0.0223 | 0.0212 | 0.0559 |
| Bow 29 B | 0.0127 | 0.0222 | 0.0217 | 0.0567 |
| Bow 30 A | 0.0142 | 0.0229 | 0.0236 | 0.0607 |
| Bow 31 A | 0.0129 | 0.0224 | 0.0210 | 0.0563 |
| Bow 33 A | 0.0125 | 0.0220 | 0.0203 | 0.0548 |
| Bow 30 B | 0.0146 | 0.0230 | 0.0249 | 0.0624 |
| Bow 31 B | 0.0134 | 0.0226 | 0.0216 | 0.0576 |
| Bow 33 B | 0.0126 | 0.0221 | 0.0206 | 0.0554 |
| Control Bow 1 | 0.0148 | 0.0235 | 0.0296 | 0.0679 |
| Control Bow 2 | 0.0130 | 0.0223 | 0.0226 | 0.0579 |

The data set forth in Table 4A suggests that Bows 26A/B, 27A/B, 28A/B, 29A/B, 30A/B, 31A/B, and 33A/B perform similarly to Bows 26-31 and 33 above. As described above, the only difference in the Bows is the choice of polymer. Accordingly, the same results associated with the inventive Bows formed using nylon 6 can also be associated with the inventive Bows formed using PBT and/or PP.

### Evaluation of Weight as a Function of Thickness of Plurality of Ribs:

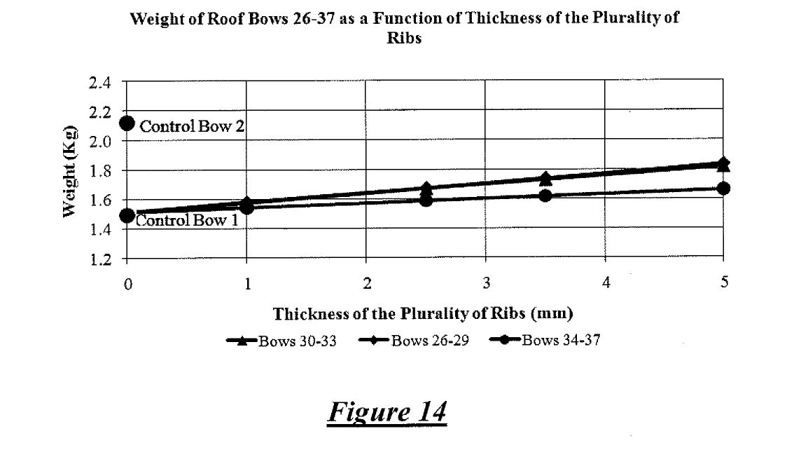

The Bows 1-37 (including Bows 26A/B-31A/B and 33A/B) and Control Blows 1-12 are also weighed to determine a total weight based on the differences in bow design and thickness (mm). The Control Bows 1-12 are used as comparative examples. The weight of each of the Bows 1-37 and the Control Bows 1-12 are set forth in Table 5 below in kilograms. The weights relative to Bows 26-37 (not including Bows 26A/B-31A/B and 33A/B) are set forth in FIG. 14.

TABLE 5

| | Weight (Kg) |
|---|---|
| Control Bow 1 | 1.510 |
| Control Bow 2 | 1.938 |
| Control Bow 3 | 1.104 |
| Control Bow 4 | 1.304 |
| Control Bow 5 | 1.405 |
| Control Bow 6 | 1.446 |
| Control Bow 7 | 1.646 |
| Control Bow 8 | 1.747 |
| Control Bow 9 | 1.927 |
| Control Bow 10 | 1.815 |
| Control Bow 11 | 1.871 |
| Control Bow 12 | 1.899 |
| Bow 1 | 2.090 |
| Bow 2 | 1.890 |
| Bow 3 | 1.690 |
| Bow 4 | 2.230 |
| Bow 5 | 1.910 |
| Bow 6 | 1.616 |
| Bow 7 | 1.730 |
| Bow 8 | 1.674 |
| Bow 9 | 1.740 |
| Bow 10 | 1.839 |
| Bow 11 | 1.670 |
| Bow 12 | 1.730 |
| Bow 13 | 1.272 |
| Bow 14 | 1.473 |
| Bow 15 | 1.473 |
| Bow 16 | 1.674 |
| Bow 17 | 1.539 |
| Bow 18 | 1.639 |
| Bow 19 | 1.740 |
| Bow 20 | 1.670 |
| Bow 21 | 1.460 |
| Bow 22 | 1.260 |
| Bow 23 | 1.730 |
| Bow 24 | 1.520 |
| Bow 25 | 1.320 |
| Bow 26 | 1.580 |
| Bow 27 | 1.674 |
| Bow 28 | 1.740 |
| Bow 29 | 1.839 |
| Bow 26 A | 1.581 |
| Bow 27 A | 1.694 |
| Bow 28 A | 1.770 |
| Bow 29 A | 1.884 |
| Bow 26 B | 1.565 |
| Bow 27 B | 1.654 |
| Bow 28 B | 1.714 |
| Bow 29 B | 1.803 |
| Bow 30 | 1.573 |
| Bow 31 | 1.670 |
| Bow 32 | 1.740 |
| Bow 33 | 1.820 |
| Bow 30 A | 1.570 |
| Bow 31 A | 1.678 |
| Bow 33 A | 1.857 |
| Bow 30 B | 1.555 |
| Bow 31 B | 1.640 |
| Bow 33 B | 1.781 |
| Bow 34 | 1.540 |
| Bow 35 | 1.586 |
| Bow 36 | 1.616 |
| Bow 37 | 1.660 |

### Summary of Data Set Forth in Examples:

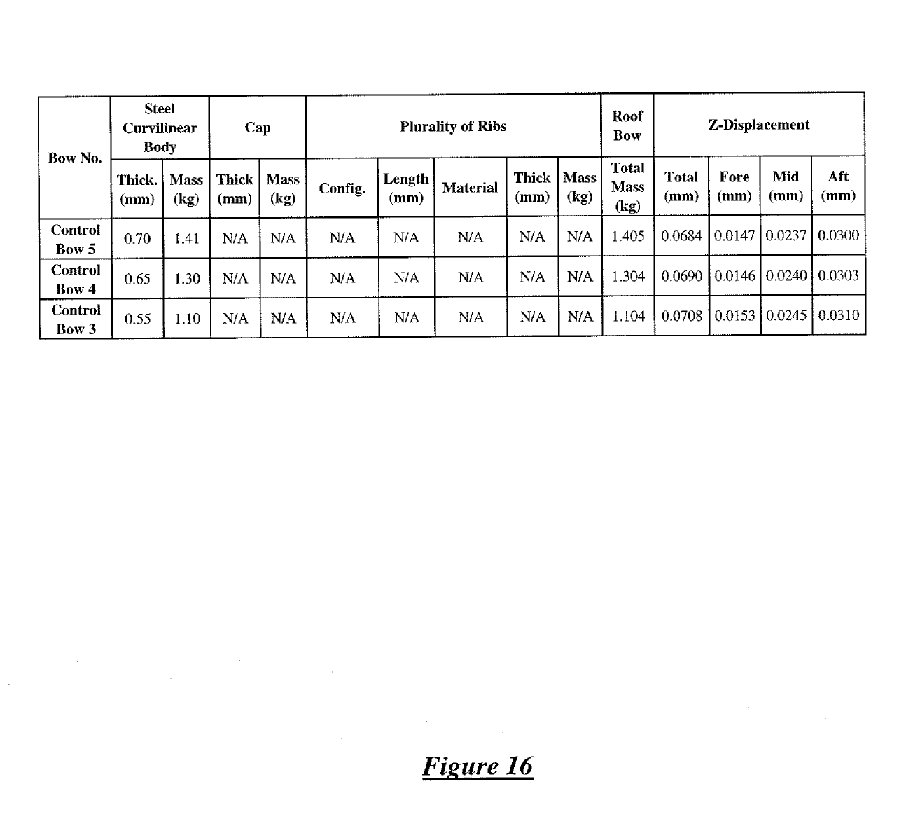

The data associated with the evaluation of Bows 1-37 (including Bows 26A/B-31A/B and 33A/B) and Comparative Bows 1-12 is summarized in the table in FIGS. 15 and 16. FIG. 15 displays the data sorted relative to Bow number, as described above. FIG. 16 displays the data of FIG. 15 sorted in ascending order based on total Z-displacement (mm). In addition, FIGS. 15 and 16 include additional data points not particularly described above yet still measured relative to the aforementioned Bows.

The data set forth above and summarized in FIGS. 15 and 16 suggests that the various embodiments of this invention not only reduce noise and vibration (represented as Z-displacement) as compared to all steel Control Bows but, in many examples, also to steel Control Bows that include large nylon 6 caps attached thereto. The nylon 6 caps greatly increase cost and weight of the Control Bows and thus are disfavored.

The data also suggests that the various embodiments of this invention contribute to weight savings as compared to the Control Bows. When used in motorized vehicles, these embodiments represent a reduction in NVH, an improvement in fuel economy related to the reduced overall weight of the vehicle, and increased energy efficiency that is also related to the reduced overall weight. Said differently, the instant invention provides special and unexpected results associated at least with reduction in NVH and also in weight savings, fuel economy, and energy efficiency, especially when compared to the Control Bows.

It is to be understood that one or more of the values described above may vary by ±5%, ±10%, ±15%, ±20%, ±25%, ±30%, etc. so long as the variance remains within the scope of the invention. It is also to be understood that the terminology “substantially” may refer to an entire amount or an amount of greater than about 50, 55, 60, 65, 70, 75, 80, 85, 90, 95, 96, 97, 98, or 99, percent. It is further to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The subject matter of all combinations of independent and dependent claims, both singly and multiply dependent, is herein expressly contemplated but is not described in detail for the sake of brevity. The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A roof bow comprising:
a body having a length and two ends spaced apart from each other, wherein said body comprises a metal, has thickness from about 0.25 mm to about 2 mm substantially along said length, and defines a base and first and second edges extending from said base, wherein each of said base and said first and second edges extend substantially along the length between said ends and wherein said first and second edges are each disposed transverse to said base and laterally spaced apart from each other substantially along said length; and
a plurality of ribs having a thickness from about 0.5 mm to about 5 mm and comprising a polymer, wherein said plurality of ribs is disposed between said first and second edges and coupled to said body.

2. A roof bow as set forth in claim 1 further comprising a ridge extending from said base substantially along said length of said body between said ends thereby defining a first trough between said ridge and said first edge and a second trough between said ridge and said second edge wherein said plurality of ribs is disposed in at least one of said first and second troughs.

3. A roof bow as set forth in claim 2 wherein said body has an axis extending approximately perpendicularly therefrom wherein said plurality of ribs is disposed transverse to said axis at an angle of from about 35 to about 85 degrees.

4. A roof bow as set forth in claim 2 wherein said body has an axis extending approximately perpendicularly therefrom wherein said plurality of ribs is disposed transverse to said axis at an angle of from about 5 to about 35 degrees.

5. A roof bow as set forth in claim 2 wherein said body has an axis extending approximately perpendicularly therefrom wherein said plurality of ribs is disposed along said axis.

6. A roof bow as set forth in claim 2 wherein said ridge further defines a third trough on a bottom side of said body and wherein a second plurality of ribs is disposed in said third trough.

7. A roof bow as set forth in claim 6 wherein said body has an axis extending approximately perpendicularly therefrom wherein each of said second plurality of ribs is disposed transverse to said axis at an angle of from about 35 to about 85 degrees.

8. A roof bow as set forth in claim 6 wherein said body has an axis extending approximately perpendicularly therefrom wherein each of said second plurality of ribs is disposed transverse to said axis at an angle of from about 5 to about 35 degrees.

9. A roof bow as set forth in claim 6 wherein said body has an axis extending approximately perpendicularly therefrom wherein each of said second plurality of ribs is disposed along said axis.

10. A roof bow as set forth in claim 1 wherein said polymer is further defined as nylon 6.

11. A roof bow as set forth in claim 1 wherein said polymer is further defined as polybutylene terephthalate.

12. A roof bow as set forth in claim 1 wherein said polymer is further defined as polypropylene.

13. A method of forming a roof bow as set forth in claim 1, said method comprising the steps of providing the body, providing the plurality of ribs, and disposing the plurality of ribs in the body.

14. A vehicle comprising said roof bow as set forth in claim 1.

15. A roof assembly connected to a frame of a motorized vehicle, said roof assembly comprising:
a pair of side rail members laterally spaced from each other and disposed approximately parallel to said frame of said motorized vehicle;
a pair of pillars connected to said frame of said motorized vehicle that are laterally spaced from each other, disposed approximately perpendicular to said frame of said motorized vehicle, and that are connected to said pair of side rail members; and
a roof bow disposed between said pair of side rail members and said pair of pillars, wherein said roof bow comprises;
a body having a length and two ends spaced apart from each other, wherein said body comprises a metal, has a thickness from about 0.25 mm to about 2 mm substantially along said length, and defines a base and first and second edges extending from said base, wherein each of said base and said first and second edges extend substantially along the length between said ends and wherein said first and second edges are each disposed transverse to said base and laterally spaced apart from each other substantially along said length, and
a plurality of ribs having a thickness from about 0.5 mm to about 5 mm and comprising a polymer, wherein said plurality of ribs is disposed between said first and second edges and coupled to said body.

16. A roof assembly as set forth in claim 15 wherein said roof bow further comprises a ridge extending from said base substantially along said length of said body between said ends thereby defining a first trough between said ridge and said first edge and a second trough between said ridge and said second edge wherein said plurality of ribs is disposed in at least one of said first and second troughs.

17. A roof assembly as set forth in claim 16 wherein said body has an axis extending approximately perpendicularly therefrom wherein said plurality of ribs is disposed transverse to said axis at an angle of from about 35 to about 85 degrees.

18. A roof assembly as set forth in claim 16 wherein said body has an axis extending approximately perpendicularly therefrom wherein said plurality of ribs is disposed transverse to said axis at an angle of from about 5 to about 35 degrees.

19. A roof assembly as set forth in claim 16 wherein said body has an axis extending approximately perpendicularly therefrom wherein said plurality of ribs is disposed along said axis.

20. A roof assembly as set forth in claim 15 wherein said ridge further defines a third trough on a bottom side of said body and wherein a second plurality of ribs is disposed in said third trough.

21-28. (canceled)
